(19) United States
(12) Patent Application Publication
(10) Pub. No.: US 2026/0313046 A1
(43) Pub. Date: Oct. 8, 2026

(54) PACKET DATA CONVERGENCE PROTOCOL SERVICE DATA UNIT CONCATENATION

(71) Applicant: APPLE INC., Cupertino, CA (US)

(72) Inventors: Fangli Xu, Beijing (CN); Ping-Heng Kuo, London (GB); Ralf Rossbach, Munich (DE); Naveen Kumar R Palle Venkata, San Diego, CA (US); Yuqin Chen, Beijing (CN); Peng Cheng, Beijing (CN); Zhibin Wu, Los Altos, CA (US); Haijing Hu, Los Gatos, CA (US); Behrouz Aghili, San Diego, CA (US); Shu Guo, Beijing (CN)

(21) Appl. No.: 19/641,005

(22) Filed: Apr. 7, 2026

Related U.S. Application Data
(60) Provisional application No. 63/785,243, filed on Apr. 8, 2025.

(51) Int. Cl. H04L 69/04; H04L 47/34; H04L 69/22

(52) U.S. Cl. CPC H04L 69/04; H04L 47/34; H04L 69/22

(57) ABSTRACT

Apparatuses, systems, and methods are described for packet data convergence protocol (PDCP) service data unit (SDU) concatenation. A user equipment (UE) may identify multiple PDCP SDUs for transmission to a network node, generate a concatenated PDCP packet data unit (PDU) that includes the multiple PDCP SDUs and a header. The UE may transmit the concatenated PDCP PDU to the network node.

### TECHNICAL FIELD

This application relates generally to wireless communication systems, including systems using packet data convergence protocols.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example block diagram of a downlink layer 2 (L2) structure in accordance with some embodiments.

FIG. 2 illustrates an example block diagram of a downlink layer 2 structure in accordance with some embodiments.

FIG. 3 illustrates an example block diagram of a L2 structure for downlink with carrier aggregation (CA) configured in accordance with some embodiments.

FIG. 4 illustrates an example block diagram 402 of L2 structure for uplink with CA configured in accordance with some embodiments.

FIG. 5 illustrates an example of the L2 data flow in accordance with some embodiments.

FIG. 6 illustrates an example structure view of a PDCP sublayer in accordance with some embodiments.

FIG. 7 illustrates an example functional view of a PDCP sublayer in accordance with some embodiments.

FIG. 8 illustrates an example of how current L2 operation may be improved with PDCP concatenation in accordance with some embodiments.

FIG. 9 illustrates Concatenation Model 1, in which multiple PDCP Service Data Units (SDUs) are concatenated into a single PDCP Protocol Data Unit (PDU) in accordance with some embodiments.

FIG. 10 illustrates Concatenation Model 2, where multiple PDCP SDUs are again concatenated into a single PDCP PDU in accordance with some embodiments.

FIG. 11 illustrates a functional view of a PDCP layer where security protection is performed per PDCP SDU (PDCP Architecture 1) in accordance with some embodiments.

FIG. 12 illustrates a block diagram of a C-PDCP PDU where the security operation for each PDCP SDU is based on its own SN/counter.

FIG. 13 illustrates a functional view of a PDCP layer where security protection is performed for concatenated PDCP PDU (PDCP Architecture 2) in accordance with some embodiments.

FIG. 14 illustrates a block diagram of a C-PDCP PDU where the security operation for the C-PDCP PDU based on the counter of the SN/Counter of the first SDU in C-PDCP PDU in accordance with some embodiments.

FIG. 15 illustrates an example block diagram of a C-PDCP PDU where the size of PDCP SDUs can be different, in accordance with some embodiments.

FIG. 16 illustrates an example block diagram of a C-PDCP PDU where the size of PDCP SDUs is the same, in accordance with some embodiments.

FIG. 17 illustrates a condition to perform the PDCP concatenation based on a timer in accordance with some embodiments.

FIG. 18 illustrates a condition to perform the PDCP concatenation based on a PDCP SDU/packet size in accordance with some embodiments.

FIG. 19 illustrates a condition to perform the PDCP concatenation based on a Max C-PDCP PDU size/mini UL grant size in accordance with some embodiments.

FIG. 20 illustrates a condition to perform the PDCP concatenation based on radio quality in accordance with some embodiments.

FIG. 21 illustrates a condition to perform the PDCP concatenation based on a network (NW) configuration indication via L1/L2/L3 signaling in accordance with some embodiments.

FIG. 22 illustrates a condition to perform the PDCP concatenation based on a concatenation packet number in accordance with some embodiments.

FIG. 23 illustrates a condition to perform the PDCP concatenation based on a PDU set in accordance with some embodiments.

FIG. 24 illustrates a condition to perform the PDCP concatenation based on same packet type/attribute in accordance with some embodiments.

FIG. 25 illustrates a PDCP SDU discard mechanism with PDCP concatenation in accordance with some embodiments.

FIG. 26 illustrates PDCP SDU retransmission with PDCP concatenation in accordance with some embodiments.

FIG. 27 illustrates a method for a UE in accordance with some embodiments.

FIG. 28 illustrates a method for a network node in accordance with some embodiments.

FIG. 29 illustrates an example architecture of a wireless communication system, according to embodiments disclosed herein.

FIG. 30 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

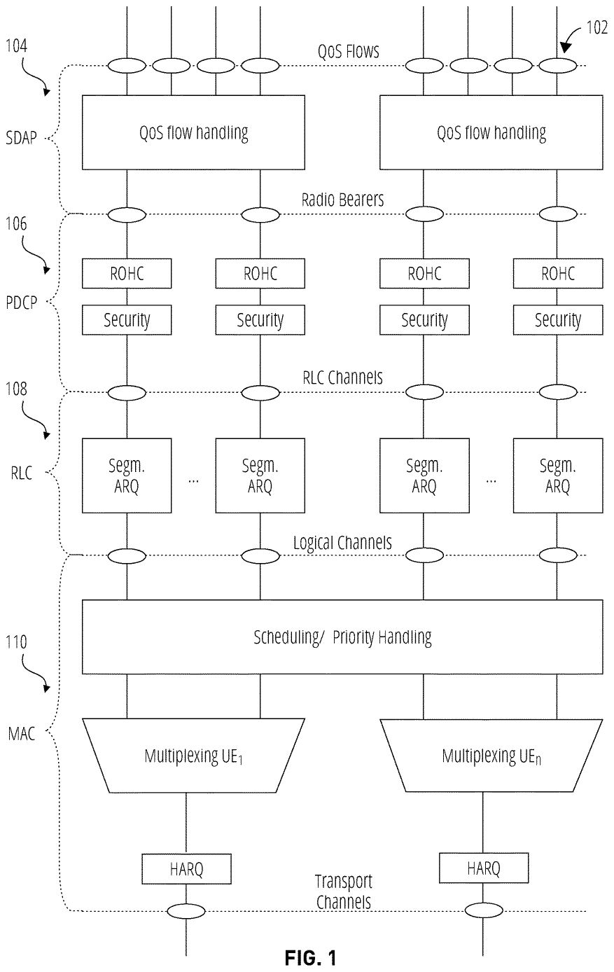

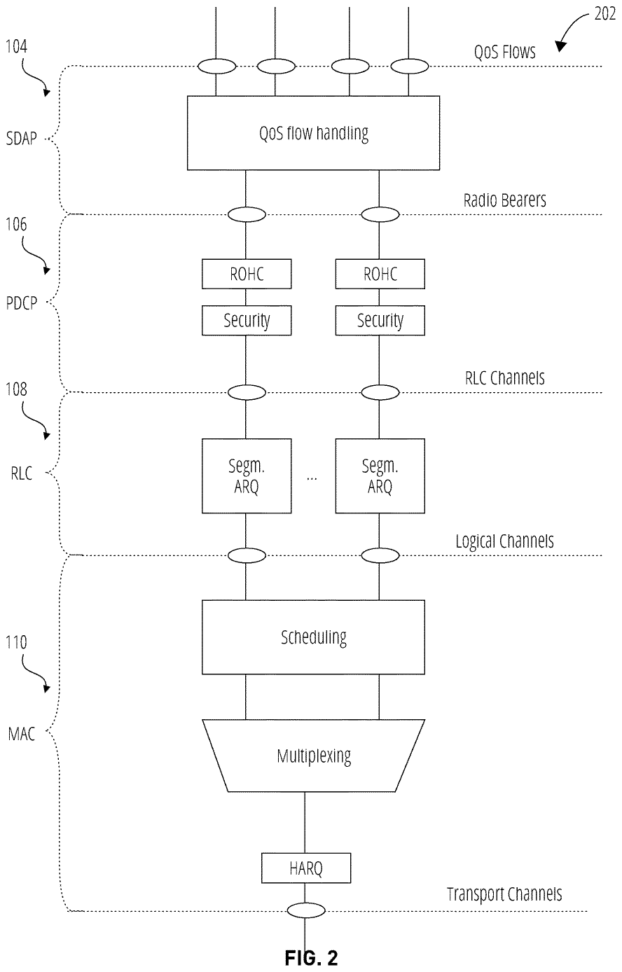

FIG. 1 illustrates an example block diagram 102 of a downlink layer 2 (L2) structure in accordance with some embodiments. FIG. 2 illustrates an example block diagram 202 of a downlink layer 2 structure in accordance with some embodiments.

As shown, the L2 architecture of a New Radio (NR) system is partitioned into four sublayers: a Medium Access Control (MAC) sublayer 110, a Radio Link Control (RLC) sublayer 108, a Packet Data Convergence Protocol (PDCP) sublayer PDCP sublayer 106, and a Service Data Adaptation Protocol (SDAP) sublayer 104.

The physical layer offers to the MAC sublayer 110 transport channels. The MAC sublayer 110 offers to the RLC sublayer 108 logical channels. The RLC sublayer 108 offers to the PDCP sublayer 106 RLC channels. The PDCP sublayer 106 offers to the SDAP sublayer 104 radio bearers. The SDAP sublayer 104 offers to core network (e.g., 5GC) QoS flows. Comp. refers to header compression (e.g., robust header compression (ROHC) or uplink data compression, and Segm. refers to segmentation.

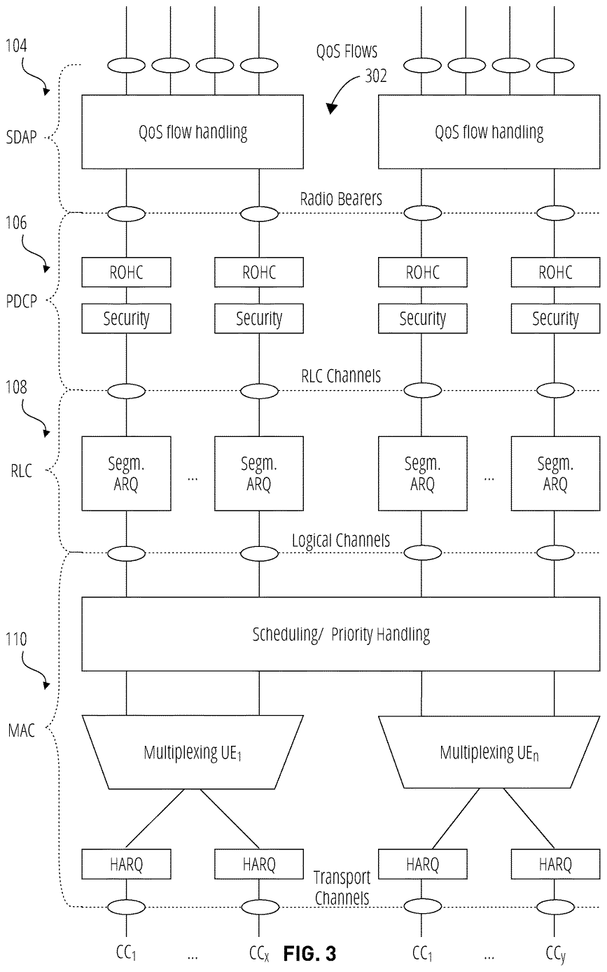

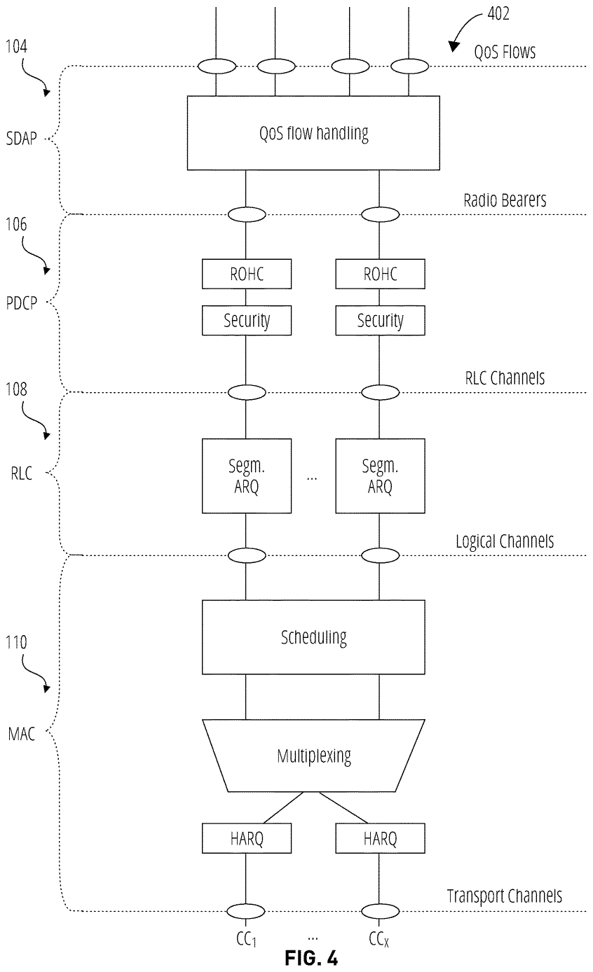

FIG. 3 illustrates an example block diagram 302 of a L2 structure for downlink with carrier aggregation (CA) configured in accordance with some embodiments. FIG. 4 illustrates an example block diagram 402 of L2 structure for uplink with CA configured in accordance with some embodiments. In case of carrier aggregation (CA), the multi-carrier nature of the physical layer is only exposed to the MAC layer for which one hybrid automatic repeat-request (HARQ) entity is per serving cell. In both uplink and downlink, there is one independent HARQ entity per serving cell and one transport block is generated per assignment/grant per serving cell in the absence of spatial multiplexing. Each transport block and its potential HARQ retransmissions are mapped to a single serving cell.

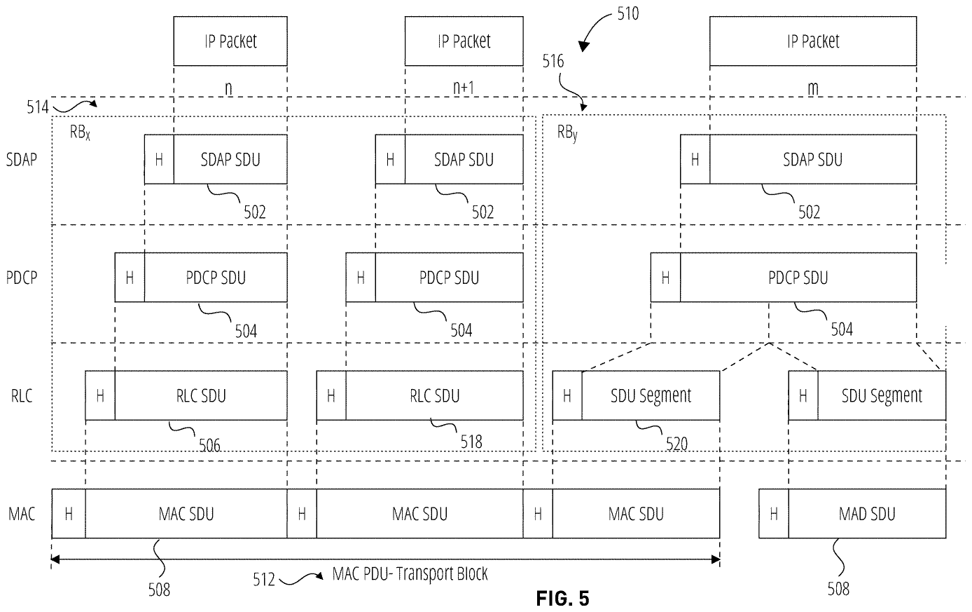

FIG. 5 illustrates an example of the L2 data flow 510 in accordance with some embodiments. In the illustrated embodiment, a transport block 512 is generated by MAC by concatenating two RLC packet data units (PDUs) (RLC PDU 506 and RLC PDU 518) from Radio Bearer x (RBx 514) and one RLC PDU (RLC PDU 520) from RBy 516. The two RLC PDUs from RBx 514 each corresponds to one IP packet (n and n+1) while the RLC PDU from RBy 516 is a segment of an IP packet (m).

Note that in the illustrated embodiments H depicts the headers and subheaders of a PDU. In the illustrated embodiment, multiple Headers are to be processed for each IP packet, which results in a certain amount of overhead. In the illustrated embodiment, when the SDAP sublayer generates the SDAP PDUs 502 from the packet it adds a header. Similarly, the PDCP generates the PDCP PDUs 504 from the SDAP PDUs 502 by adding a header. Also, when RLC sublayer generates the RLC PDUs (e.g., RLC PDU 506, RLC PDU 518, and RLC PDU 520) from the PDCP PDUs 504 it adds a header. Further, in the illustrated embodiment, the MAC sublayer also adds headers. These headers may each add a certain amount of overhead.

The L2 sublayers may have the following functions. The MAC sublayer may provide: mapping between logical channels and transport channels; multiplexing/demultiplexing of MAC service data units (SDUs) belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and padding. The granularity of the MAC sublayer may be per cell group.

The RLC sublayer may facilitate: Transparent Mode (TM); Unacknowledged Mode (UM); Acknowledged Mode (AM). The granularity of the RLC sublayer may be per resource block (RPB).

The PDCP sublayer may facilitate: transfer of data (user plane or control plane); maintenance of PDCP sequence numbers (SNs); header compression and decompression using the robust header compression (ROHC) protocol; header compression and decompression using ethernet header compression (EHC) protocol; compression and decompression of uplink PDCP SDUs: DEFLATE based UDC only; ciphering and deciphering; integrity protection and integrity verification; timer based SDU discard; for split bearers, routing; duplication; reordering and in-order delivery; out-of-order delivery; duplicate discarding. The granularity of the PDCP sublayer may be per RB.

The SDAP sublayer may facilitate: mapping between a QoS flow and a data radio bearer; marking QoS flow ID (QFI) in both DL and UL packets. The granularity of the SDAP sublayer may be per PDU session.

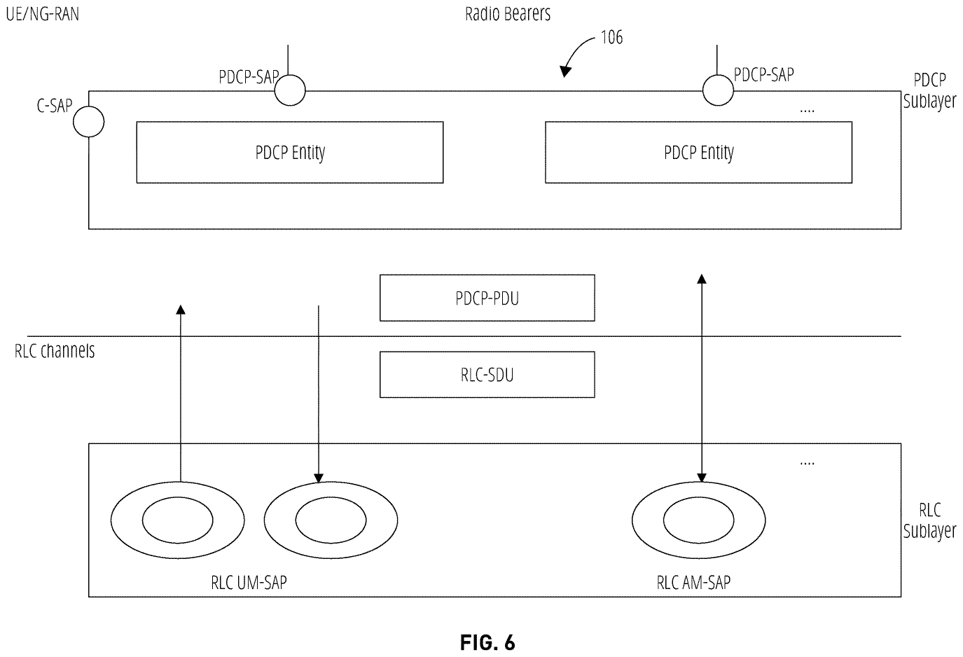

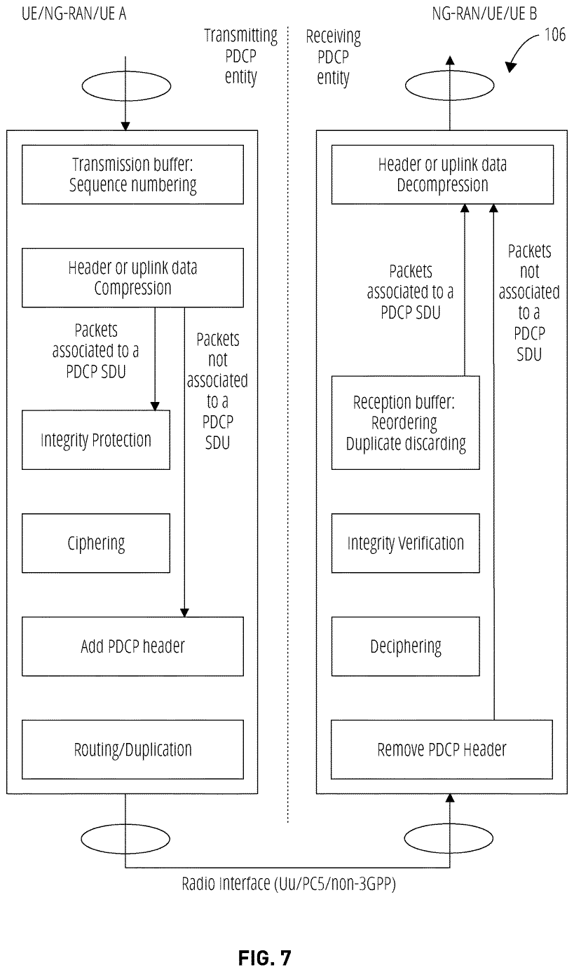

FIG. 6 illustrates an example structure view of a PDCP sublayer 106 in accordance with some embodiments. FIG. 7 illustrates an example functional view of a PDCP sublayer 106.

The main services and functions of the PDCP sublayer 106 may include: transfer of data (user plane or control plane); maintenance of PDCP SNs; header compression and decompression using the ROHC protocol; header compression and decompression using EHC protocol; compression and decompression of uplink PDCP SDUs: DEFLATE based UDC only; ciphering and deciphering; integrity protection and integrity verification; timer based SDU discard; for split bearers, routing; duplication; reordering and in-order delivery; out-of-order delivery; duplicate discarding. The granularity of the PDCP sublayer may be per RB.

The NR PDCP model features a one-to-one mapping between PDCP SDU and PDCP PDU. Currently, security handling is per PDCP SDU, and a PDCP header is added to each PDCP PDU. This design is not efficient for the transmission of multiple small packets simultaneously.

The NR PDCP model faces several issues, particularly with the handling of multiple small packets that arrive within a short period and are transmitted together. Processing a large number of small packets leads to increased CPU load. As shown in FIG. 5, in some embodiments, each SDU is subject to header processing at multiple protocol layers, such as SDAP, PDCP, RLC, and MAC, resulting in significant header processing overhead for multiple small packets. Additionally, the time required for payload processing does not scale linearly with payload size. Further, the amount of headers from small packets may lead to high CPU load. There are also hardware-imposed limits on the maximum number of packets that can be processed. These inefficiencies are prominent in scenarios involving TCP ACKs, XR, and applications that generate numerous small packets where low latency is not a primary concern.

In 6G networks, new services such as AI/ML and sensing will be introduced. Some models of the new services may have significant characteristics of frequent transmission of small data packets. While certain models of these services may handle large payloads, it is anticipated that others, particularly those involving applications like AI/ML sensing, will be characterized by the frequent transmission of small packets. One of the 6G network design mandates is the improvement of transmission efficiency for these frequent small data transmissions.

Some embodiments herein use a new PDCP model design to enhance efficiency and reduce signaling overhead when handling scenarios involving the simultaneous transmission of multiple small packets. If multiple small packets from one DRB arrive in a short time and are assembled into one MAC PDU, the PDCP layer can concatenate the multiple packets in one PDCP PDU and deliver to lower layers for processing. This approach may allow the PDCP, RLC, and MAC layers to optimize processing time and reduce L2 overhead, leading to more efficient handling of frequent small data transmissions.

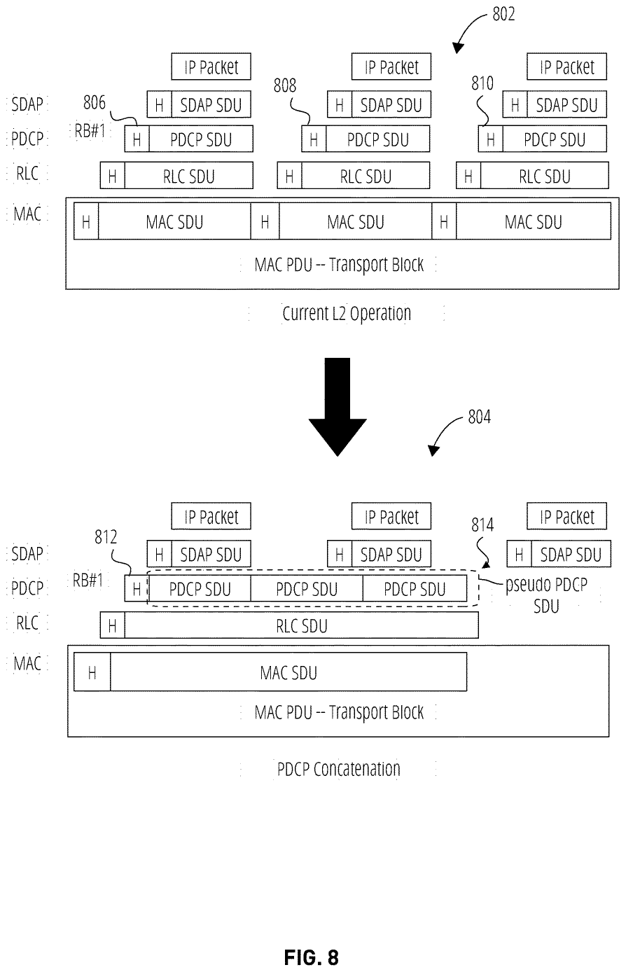

FIG. 8 illustrates an example of how current L2 operation (e.g., block diagram 802) may be improved with PDCP concatenation (e.g., block diagram 804) in accordance with some embodiments. In the example of PDCP concatenation, UE can perform the security processing once instead of three times for each IP packet, and add one MAC-I instead of three, add one PDCP/RLC header (e.g., header 812) instead of three (e.g., header 806, header 808, header 810).

The figure illustrates the efficiency gained through PDCP concatenation compared to the legacy method of handling small packets. In the traditional approach, if three small packets arrive in a short time, each packet is processed individually at the PDCP layer, requiring separate security handling (e.g., integrity protection), and each is appended with its own PDCP/RLC header and MAC-I value.

With PDCP concatenation, the three small packets are combined into a single concatenated PDCP PDU 814. The concatenated PDCP PDU 814 may undergo only one instance of security processing, may be appended with a single PDCP/RLC header, and may include just one MAC-I field. This consolidation may reduce header overhead and signaling, as well as CPU and hardware processing load. The figure visually contrasts the two methods, highlighting the reduced number of headers and security fields when concatenation is employed, thereby illustrating the benefits in processing and signaling efficiency.

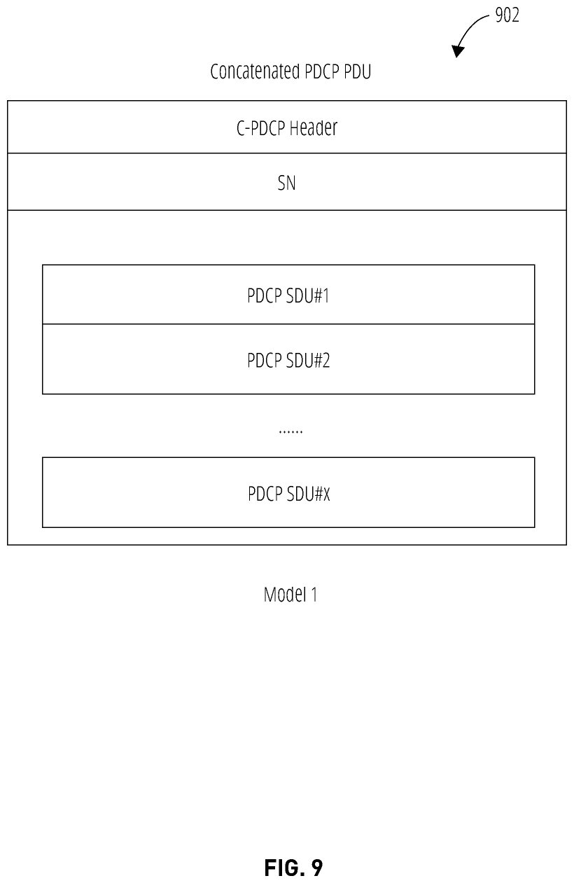

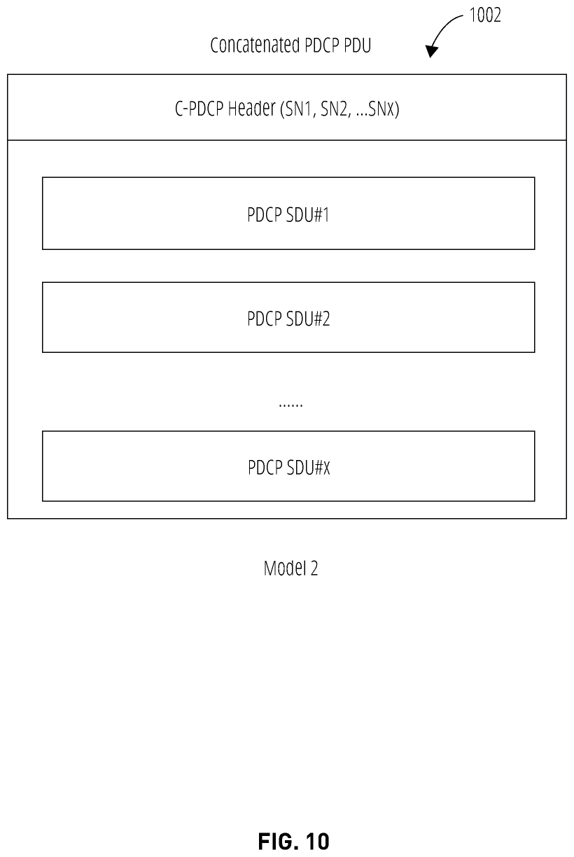

FIG. 9 and FIG. 10 illustrate two potential PDCP concatenation models in accordance with some embodiments.

FIG. 9 illustrates Concatenation Model 1 902, in which multiple PDCP Service Data Units (SDUs) are concatenated into a single PDCP Protocol Data Unit (PDU) in accordance with some embodiments. In this model, only one PDCP Sequence Number (SN) is assigned to the concatenated PDCP PDU. When multiple individual SDUs arrive at the PDCP layer, they may be aggregated and encapsulated into a single PDU. In the embodiment illustrated in FIG. 9, this PDU includes a single PDCP SN in its header, which provides identification and facilitates protocol operations such as reordering and retransmission at the PDCP layer. All concatenated SDUs within the PDU are thus associated with the same PDCP SN. This approach reduces signaling and header overhead by consolidating multiple SDUs into one PDCP PDU with a single sequence number.

FIG. 10 illustrates Concatenation Model 2 1002, where multiple PDCP SDUs are again concatenated into a single PDCP PDU in accordance with some embodiments. However, in this model, each SDU within the concatenated PDU is individually associated its own PDCP SN. The figure depicts several SDUs concatenated at the PDCP layer into one PDU for transmission. Despite being sent as one concatenated entity, headers within the PDU preserve a unique PDCP SN for each constituent SDU. This model may allow for independent identification, reordering, and retransmission of each SDU. The allocation of a separate SN per SDU within a concatenated PDU offers may offer enhanced flexibility, particularly for supporting dynamic mode switching between concatenated and non-concatenated transmission, and optimizing network adaptation based on radio conditions.

Together, these figures (FIG. 9 and FIG. 10) illustrate two distinct methods for PDCP SN assignment in the context of PDCP SDU concatenation: assigning a single SN per concatenated unit (Model 1), or assigning an individual SN to each SDU within a concatenated unit (Model 2). The embodiments herein focus on details regarding Model 2.

Some embodiments herein relate to a PDCP design model based on one SN per PDCP SDU (e.g., shown in FIG. 10) when multiple PDCP SDUs are concatenated into a single concatenated PDCP PDU. When multiple PDCP SDUs are concatenated together, the PDCP SN information may be optimized and carried in a concatenated-PDCP (C-PDCP) header. As a result, PDCP sequence numbering remains packet-based at the SDU level, while the signaling overhead associated with multiple SN fields can be reduced when aggregation is applied. This may preserve PDCP-layer processing consistency while improving transmission efficiency.

The PDCP SDU specific SN allocation in this model may support multiple operational scenarios. One representative scenario involves switching between concatenated PDCP mode and legacy PDCP mode. Because the PDCP SN is pre-allocated per PDCP SDU, the system can transition between these modes without altering fundamental PDCP processing behavior.

Another scenario arises when the number of concatenated PDCP SDUs changes during PDCP-level packet transmission, such as during PDCP automatic repeat request (ARQ) procedures. For example, an initial transmission may aggregate four PDCP SDUs into a single transmission unit, while a subsequent retransmission may involve only two PDCP SDUs. In such cases, designs that rely on a single sequence number per aggregated packet may be difficult to adapt. By contrast, the proposed model may maintain SDU-level SN allocation, enabling flexible retransmission even when the aggregation structure changes.

A further scenario addressed by this model is the dynamic change of concatenation conditions. For instance, under favorable radio conditions, larger packets with more aggregated PDCP SDUs may be transmitted, whereas under degraded radio quality, smaller packets with fewer aggregated PDCP SDUs may be preferred. In the proposed design, the PDCP layer may pre-allocate the sequence number for each PDCP SDU and may dynamically determine how many PDCP SDUs are aggregated into a single transmission unit during online processing.

If most PDCP functions in reception side (Rx) and transmission side (Tx) side can be performed based on PDCP SDU granularity regardless of the PDCP mode, such a model may be more flexible and adaptable to handle the dynamical change situation. By allocating and managing PDCP sequence numbers at the PDCP SDU granularity, most PDCP functions on both the Tx and Rx can be performed independently of whether PDCP concatenation is enabled. As a result, PDCP operations such as sequencing, reordering, retransmission handling, and discard processing can remain consistent across different PDCP modes.

To enable the proposed PDCP concatenation model to operate effectively, several technical issues are identified and addressed in the detailed description that follows. These issues include: Issue-1-PDCP architecture with PDCP concatenation; Issue-2-PDCP PDU format with the PDCP concatenation; Issue-3-Condition to perform the PDCP concatenation; Issue-PDCP SDU discard mechanism with PDCP concatenation; Issue-5-PDCP SDU retransmission mechanism with PDCP concatenation; and Issue-6-Data forwarding between source and target gNB with the PDCP concatenation.

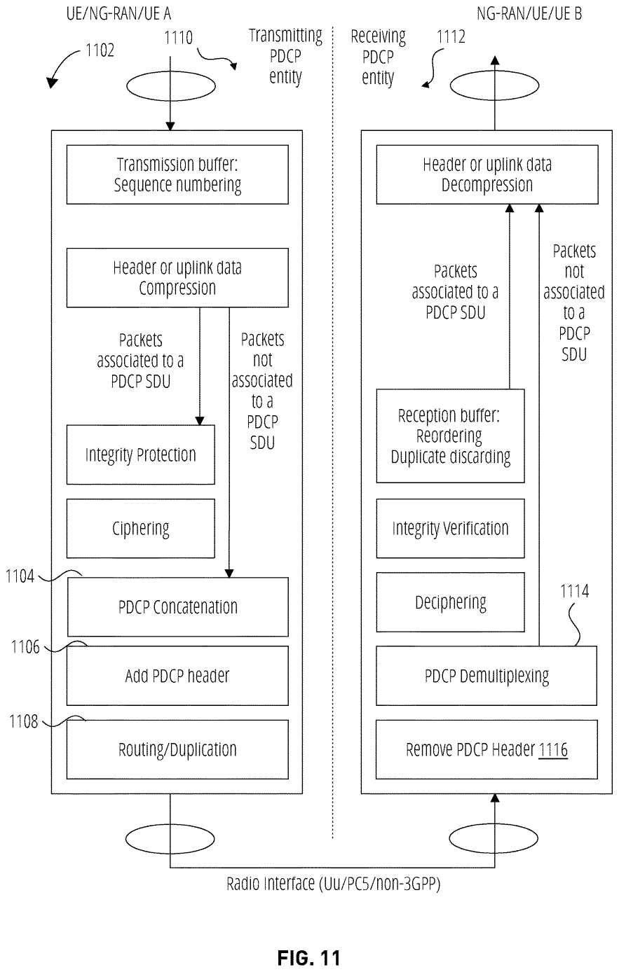

In some embodiments a first PDCP architecture (PDCP Architecture 1) may be used. FIG. 11 illustrates a functional view of a PDCP layer 1102 where security protection is performed per PDCP SDU (PDCP Architecture 1) in accordance with some embodiments. As shown, in some embodiments, the PDCP concatenation 1104 may occur at the PDCP layer prior to adding the PDCP header 1106 and routing/duplication 1108 on the Tx 1110, and PDCP demultiplexing 1114 may occur after the remove PDCP header step 1116 on the Rx Side 1112.

Security protection may be performed per PDCP SDU. For the PDCP SDU level operation the following may be implemented by the Tx side 1110 and the Rx side 1112. The Tx side 1110 may perform: sequence numbering, compression, IP, and Ciphering operations at the PDCP SDU level. The Rx side may perform: Deciphering, IV, Reordering/duplication, and decompression operations at the PDCP SDU level.

Regarding the security operation for this container C-PDCP PDU, several options may be used.

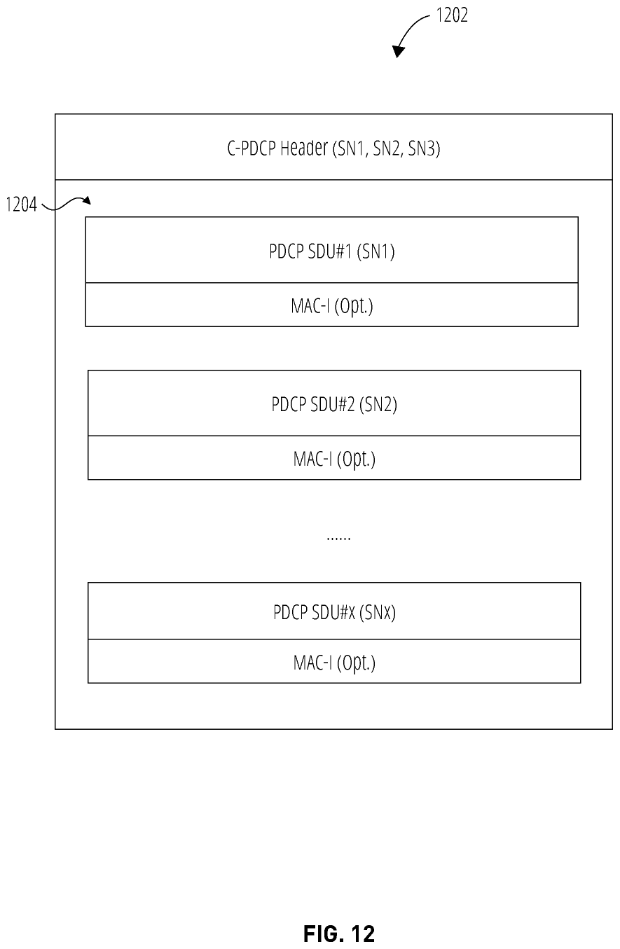

In a first option the security protection may be performed for each PDCP SDU. In some embodiments, the security operation may be based on the PDCP SDU's SN/counter. For example, FIG. 12 illustrates a block diagram 1202 of a C-PDCP PDU where the security operation for each PDCP SDU is based on its own SN/counter. For instance, PDCP SDU #1 1204 includes a MAC-I based on its own SN/counter.

In a second option, the security protection may be performed only for the first PDCP SDU. In some embodiments, no security protection may be applied on other PDCP SDUs in C-PDCP PDU. The benefit of the second option may be that the PDCP PDU size may be reduced, and the PDCP PDU processing time may be reduced (save security processing time per PDU).

In a third option, only one or a subset of PDCP SDUs in the C-PDCP PDU may be used to perform the security protection. In contrast to the second option where security protection is performed only for the first PDCP SDU, the selection of the PDCP SDU for which security protection is performed may be flexible. In some embodiments, the PDCP SDU for which security protection is performed can be the first one or the last one. In some embodiments, the PDCP SDU or which security protection is performed can be any one of the PDCP SDU. In some embodiments, the PDCP SDU for which security protection is performed can be configured by the network. Note that the UE may indicate in the header which PDCP SDU applies the security operation.

In some embodiments, one particular SDU to apply ciphering or IP operation may be considered.

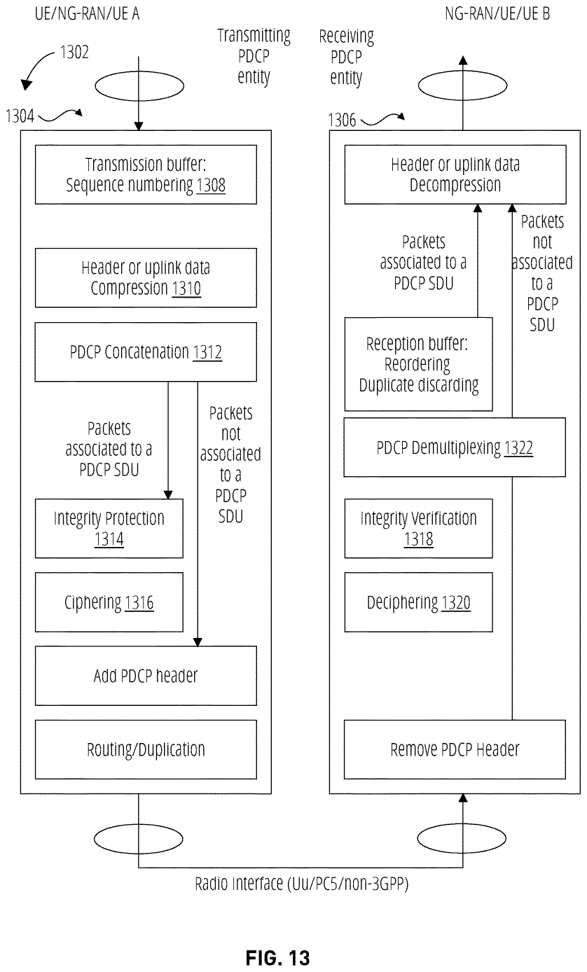

In some embodiment, referred to herein as Architecture 2, security protection is performed at the level of a concatenated PDCP protocol data unit (PDU) rather than at the individual PDCP service data unit (SDU) level. For example, FIG. 13 illustrates a functional view of a PDCP layer 1302 where security protection is performed for concatenated PDCP PDU (PDCP Architecture 2) in accordance with some embodiments.

In PDCP architecture 2, the placement and sequencing of PDCP concatenation and security-related functions within the PDCP processing is different than PDCP architecture 1. In PDCP architecture 2, PDCP concatenation is performed earlier in the transmission processing flow. On the Tx side 1304, PDCP SDU level operations may include sequence numbering 1308, and compression 1310. Thus, the PDCP sequence number (e.g., sequence numbering 1308) may be allocated per PDCP SDU, thereby preserving SDU-level sequence number management. Header compression may also performed at the PDCP SDU level prior to concatenation. Following these SDU-level operations, multiple PDCP SDUs may be concatenated 1312 to form a concatenated PDCP PDU.

After the PDCP concatenation is completed, remaining PDCP processing operations, including security protection, may be performed at the concatenated PDCP PDU level. In particular, Ciphering 1316 and Integrity Protection 1314 may be applied to the concatenated PDCP PDU as a whole, rather than being applied separately to an individual PDCP SDU. As a result, security protection may be executed once per concatenated PDCP PDU on the Tx side 1304.

On the Rx side 1306, the corresponding Integrity Verification 1318 and Deciphering 1320 may be likewise performed at the concatenated PDCP PDU level. Following successful security checking, PDCP Demultiplexing 1322 may be performed, and PDCP-level functions such as reordering and duplication discarding, and decompression may be performed. In Architecture 2 security protection may be a concatenated PDCP DPU level operation in the Rx side and Tx side.

Accordingly, in Architecture 2, PDCP operations can be categorized into two distinct levels. At the PDCP SDU level, operations may include sequence numbering and compression on the transmission side and decompression, reordering, and duplication handling on the reception side. At the concatenated PDCP PDU level, security protection may be performed on both the transmission side and the reception side.

The security operation for C-PDCP PDU may be based on the SN/Counter of a specific PDCP SDU. The specific PDCP SDU may refer to one of the following one. In some embodiments, the SN/Counter of the first PDCP SDU may be used for the security operation. In some embodiments, the SN/Counter of the last PDCP SDU may be used for the security operation. In some embodiments, any PDCP SDU selected by Tx side 1304 may be used for the security operation. In some embodiments, the Nth PDCP SDU (as configured by the network) may be used for the security operation. In some embodiments, the C-PDCP Header may carry the information about which PDCP SDU's SN/Counter info is used for the security operation.

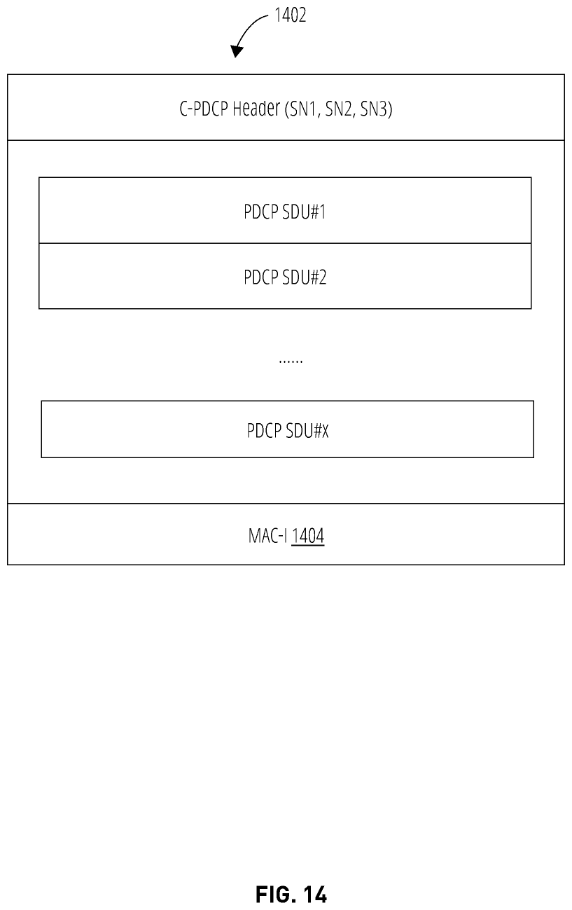

For example, FIG. 14 illustrates a block diagram 1402 of a C-PDCP PDU where the security operation for the C-PDCP PDU based on the counter of the SN/Counter of the first SDU in C-PDCP PDU in accordance with some embodiments. For instance, MAC-I 1404 may be based on the first SDU in C-PDCP PDU.

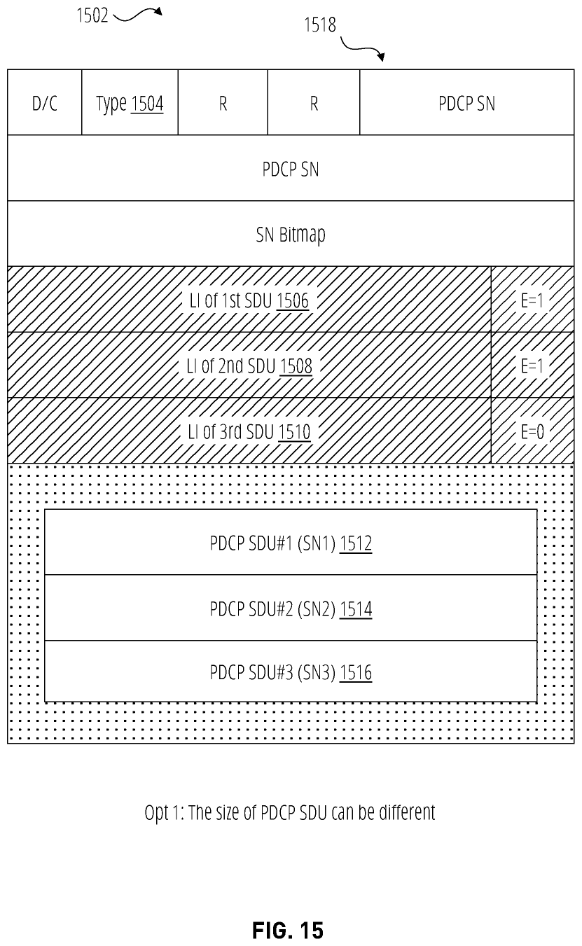

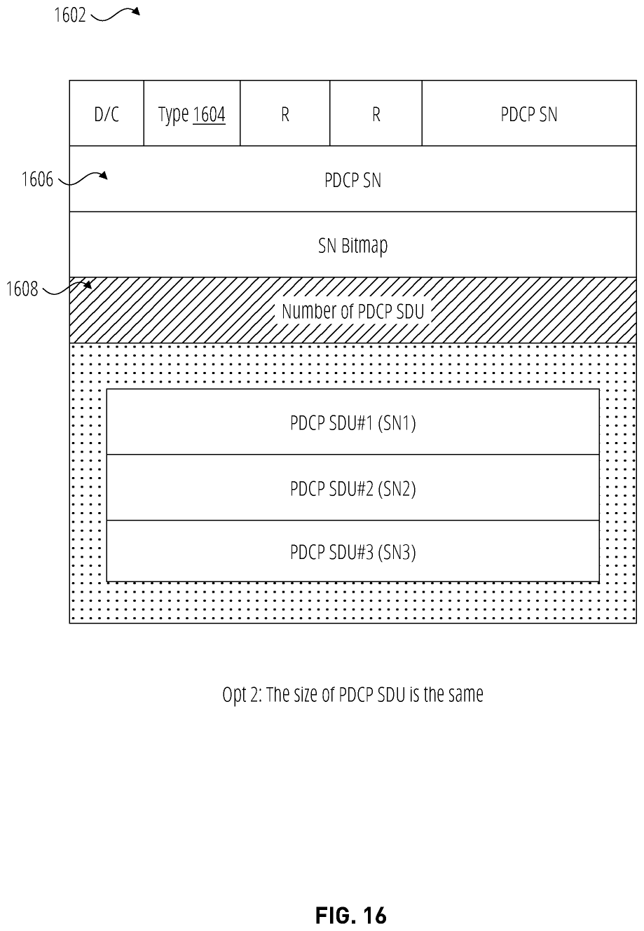

In some embodiments, the PDCP PDU may be formatted as describe below. FIG. 15 and FIG. 16 illustrate two possible formats for C-PDCP PDU. The C-PDCP header may include the following information. In some embodiments, the C-PDCP header may include a PDCP PDU type field that indicates whether the PDCP PDU is a concatenated PDCP PDU or a legacy (non-concatenated) PDCP PDU. When the PDCP PDU type indicates a concatenated PDCP PDU, the receiver may interpret the remainder of the header and payload according to the concatenated format.

The C-PDCP header may further include the SN information for the PDCP SDUs included in the C-PDCP PDU. In some embodiments, the header may include a field carrying the first PDCP SDU SN, together with an SN bitmap. The SN bitmap may indicate the presence and continuity of subsequent PDCP SDU SNs within the payload. Using this mechanism, the receiver can derive the SN for each PDCP SDU included in the concatenated PDCP PDU based on the first SN and the bitmap indication.

For example, FIG. 15 illustrates an example block diagram of a C-PDCP PDU 1502 where the size of PDCP SDUs can be different, in accordance with some embodiments. As shown, the C-PDCP header includes a PDCP PDU type field 1504 that indicates whether the PDCP PDU is a concatenated PDCP PDU or a non-concatenated PDCP PDU.

The C-PDCP header also includes a PDCP SN field 1518 for the PDCP SDUs included in the C-PDCP PDU 1502. The PDCP SN field 1518 may include an SN bitmap.

In addition, because the PDCP SDUs included in the concatenation may have different payload sizes, the C-PDCP header may include length and/or position information for each PDCP SDU (e.g., length/position field(s)). For example, L1 of 1st SDU 1506 may indicate the length of PDCP SDU #1 (SN1) 1512, L1 of 2nd SDU 1508 may indicate the length of PDCP SDU #2 (SN2) 1514, and L1 of 3rd SDU 1510 may indicate the length of PDCP SDU #3 (SN3) 1516. This length information enables the receiving side to determine the boundary between consecutive PDCP SDUs within the payload portion of the C-PDCP PDU. Based on the indicated length information, the receiver may extract each PDCP SDU correctly for further processing.

FIG. 16 illustrates an example block diagram of a C-PDCP PDU 1602 where the size of PDCP SDUs is the same, in accordance with some embodiments. Note that for this format, each PDCP SDU size may be fixed or configurable. For example, the network may configure the SDU size. As shown, the C-PDCP header includes a PDCP PDU type field 1604 that indicates whether the PDCP PDU is a concatenated PDCP PDU or a non-concatenated PDCP PDU.

The C-PDCP header also includes a PDCP SN field 1606 for the PDCP SDUs included in the C-PDCP PDU 1502. The PDCP SN field 1518 may include an SN bitmap. As shown, in some embodiments, the C-PDCP PDU 1602 may include a field 1608 that indicates a number of PDCP SDUs in the C-PDCP PDU 1602. Based on the number of PDCP SDUs and the length of the PDCP SDUs, the receiver may determine the location of the PDSCP SDUs in the C-PDCP PDU 1602.

It may be desirable to selectively perform PDCP concatenation and not perform PDCP concatenation. Accordingly, there may be certain conditions defined for when to perform the PDCP concatenation. One benefit of PDCP concatenation is L2 overhead reduction. But if the PDCP concatenation size is too large to segment in RLC layer, the benefit may be gone. The benefit of PDCP concatenation may be applicable for the multiple small data packets transmission in a short time. For the infrequent data transmission, or the packet with large size, the benefit may be gone. These considerations may be taken into account for the conditions for PDCP concatenation.

Table 1 illustrates how several factors may be used for conditions for PDCP concatenation. Note that in some embodiments a combination of the options/factors shown in table 1 may be used.

In option 1, the condition may be based on a timer. For example, in some embodiments, only the packets received within a configured period can be concatenated together. To implement the timer based option, the Tx operation may be: upon receiving one packet, UE starts the timer, and UE may start the PDCP concatenation upon the timer expiry if multiple packets have been received. Note that in some embodiments the packet can be required to meet other conditions (e.g., size).

In option 1a, some embodiments PDCP concatenation may be based on a discard time (e.g., discard timer). For example, in some embodiments, packets that arrive at similar time and whose discard timer are the same value can be concatenated together. Thus, some embodiments may consider arrival time (e.g., the timer of option 1) and the discard timer.

In option 2, some embodiments may base PDCP concatenation on the PDCP SDU size and/or packet size. For example, in some embodiments only packets that are the same size as the configured packet size, or smaller, can be considered for PDCP concatenation. To implement option 2, the following Tx operations may be performed: if the packet size is greater than the configured size, the UE may perform legacy behavior (e.g., no PDCP-concatenated). If the packet size is less than or equal to the configured size, the UE may perform PDCP concatenation, which can be combined with other factors.

In option 3, some embodiments may base PDCP concatenation on the C-PDCP SDU size/mini UL grant size. In some embodiments, the concatenated PDCP SDU size should be same or smaller than the configured size. The Tx Operation may include: when performing the PDCP concatenation, UE may take this size restriction into account.

In option 4, some embodiments may base PDCP concatenation on the radio quality. In some embodiments, PDCP concatenation functionality may be disabled when the radio quality is less than a threshold. The network may not provide big MAC PDU size for transmission. If the final PDCP PDU is too large to be segmented in RLC, the benefit may disappear.

In option 5, some embodiments may base PDCP concatenation on a network configuration and/or a network indication. The network implementation can provide the semi-static control based on its knowledge and its scheduling scheme. The configuration can be via L1, L2, or L3 signaling. Thus, the network may use dynamic signaling to enable and disable PDCP concatenation.

In option 6, some embodiments may base PDCP concatenation on repetition number and/or concatenation number. In Non-Terrestrial Network (NTN) deployment, to ensure the transmission efficiency and reliability, the network may expect UE to transmit multiple small packets in one transport block (TB) Size with transmission repetition scheme. PDCP Tx side can be based on the association between repetition number and number of voice packet to decide the concatenated number.

In option 7, some embodiments may base PDCP concatenation on PDU set. For example, in some embodiments, only the packet from one PDU set can be concatenated together.

In option 8, some embodiments may base PDCP concatenation on packet type. For example, in some embodiments, the Tx side may only concatenate the PDCP SDU with same packet type into one C-PDCP PDU, e.g. the same importance level, the same APP packet type (e.g. TCP ACK).

Note that these options can be applicable for both Model 1 and Model 2. For Model 1: The PDCP SN is associated with 1 concatenated PDCP PDU.

TABLE 1
Conditions for PDCP concatenation

| Factors of the | |
|---|---|
| condition | Description |
| Option 1: based | Only the packets received within a configured period can be |
| on timer | concatenated together. |
| | Tx operation: |
| | Upon receiving one packet, UE start the timer |
| | UE starts the PDCP concatenation upon the timer expiry if |
| | multiple packets have been received. |
| | (Note: the packet can be required to meet other conditions, e.g. |
| | size) |
| Option 1a. Based | Packets that arrive at similar time AND whose discard timer are |
| on discard time | the same value can be concatenated together. |
| Option 2: based | Only the packets with the same size of the configured packet size |
| on the PDCP | or smaller than the configured packet size can be considered for PDCP |
| SDU/packet size | concatenation. |
| | Tx Operation |
| | If the packet size > configured size, UE will perform legacy |
| | behavior. |
| | If the packet size <= configured size, UE performs the PDCP |
| | concatenation (it can work together with other factors.) |
| Option 3: based | The concatenated PDCP SDU size should be same or smaller |
| on the C-PDCP | than the configured size. |
| SDU size/mini | Tx Operation |
| UL grant size | When performing the PDCP concatenation, UE should take this |
| | size restriction into account. |
| Option 4: based | PDCP concatenation functionality is disabled when the radio |
| on the radio | quality < threshold. |
| quality | Consideration: NW may not provide big MAC PDU size for |
| | transmission. If the final PDCP PDU is too large to be segmented in RLC, |
| | the benefit will disappear. |
| Option 5: Based | Assumption: NW implementation can provide the semi-static |
| on NW | control based on its knowledge and its scheduling scheme. The config can |
| config/indication | be via L1/L2/L3 signal. |
| Option 6: Based | In NTN deployment, to ensure the transmission efficiency and |
| on repetition | reliability, NW may expect UE to transmit multiple small packets in one |
| number/ | TBSize with transmission repetition scheme. PDCP Tx side can based on |
| concatenation | the association between repetition number and number of voice packet to |
| number | decide the concatenated number. |
| Option 7: based | Only the packet from one PDU set can be concatenated together |
| on PDU set | |
| Option 8: based | Only concatenate the PDCP SDU with same packet type into one |
| on packet type | C-PDCP PDU, e.g. the same importance level, the same APP packet type |
| | (e.g. TCP ACK) |

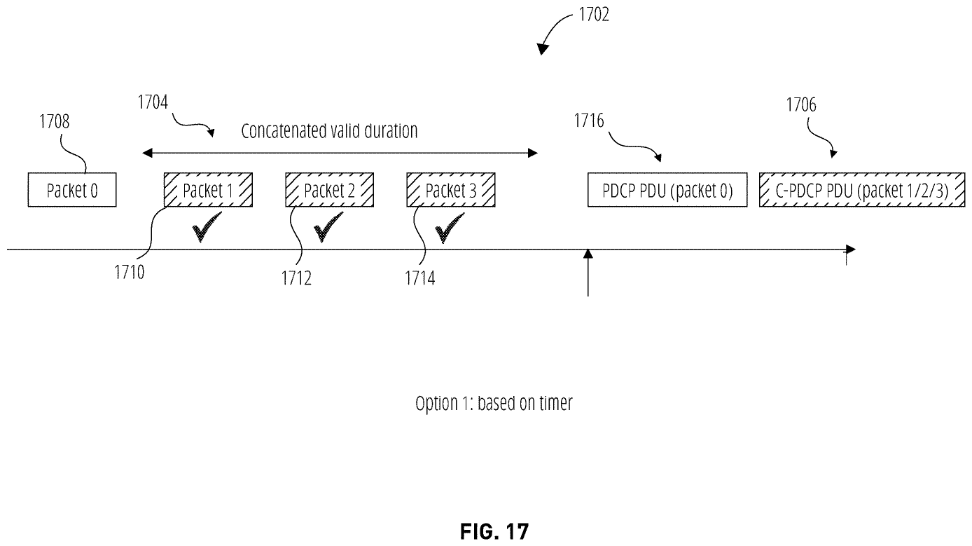

FIG. 17 illustrates an example timeline 1702 where a transmitting device (e.g., UE) performs the PDCP concatenation based on a timer in accordance with some embodiments (e.g., option 1). As shown, the packets (packet 1710, packet 1712, and packet 1714) that arrive during a concatenated valid duration 1704 may be concatenated into a single C-PDCP PDU 1706. The concatenated valid duration 1704 may be based on a timer. For example, when the transmitting device receives one packet, the transmitting device may start the timer, and start the PDCP concatenation upon the timer expiry if multiple packets have been received. As shown, other packets (e.g., packet 1708) may be sent in a separate PDCP PDU 1716.

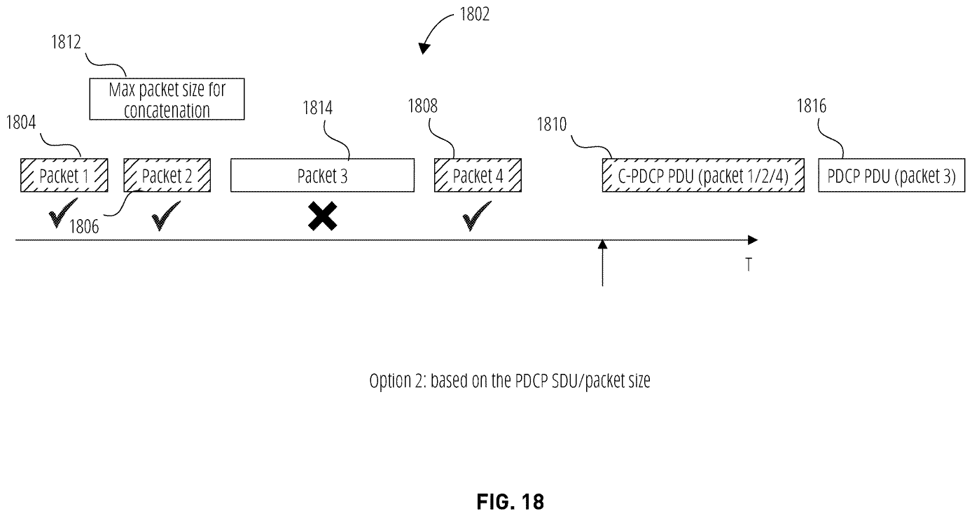

FIG. 18 illustrates an example timeline 1802 where a PDCP concatenation condition is based on the PDCP SDU/packet size in accordance with some embodiments (e.g., option 2).

For example, in the illustrated embodiment packet 1804, packet 1806, and packet 1808 are all equal to or smaller than the maximum packet size for concatenation 1812. Accordingly, the transmitting device may perform PDCP concatenation for packet 1804, packet 1806, and packet 1808 to generate C-DCP PDU 1810.

In contrast, packet 1814 is greater than the maximum packet size for concatenation 1812. Accordingly, the packet 1814 may be included in its own PDCP PDU 1816.

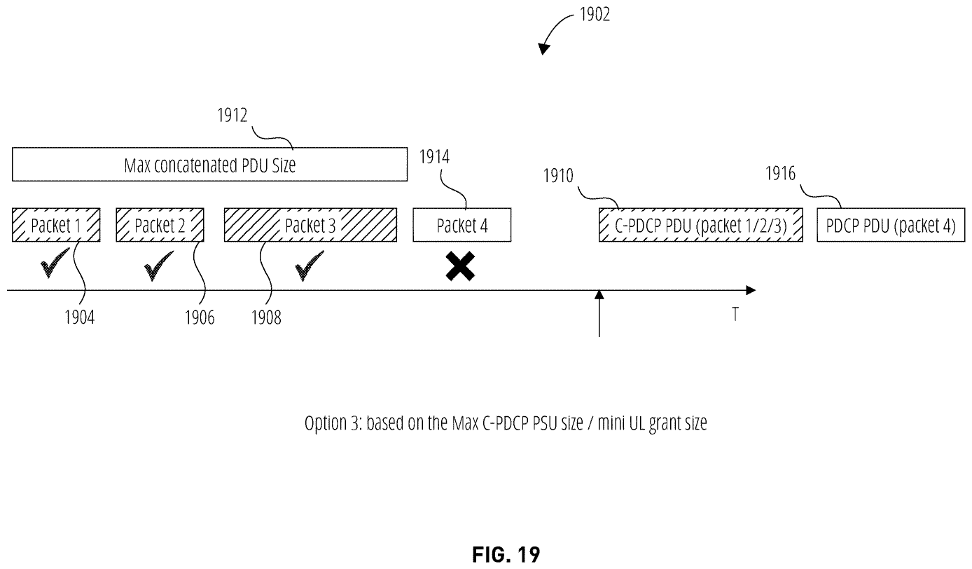

FIG. 19 illustrates an example timeline 1902 where a PDCP concatenation condition is based on a maximum C-PDCP PDU size/mini UL grant size in accordance with some embodiments (e.g., option 3). In the illustrated embodiment, the concatenated PDCP SDU size should be the same or smaller than the configured size (e.g., maximum concatenated PDU size 1912). The UE should take this size restriction into account when performing the PDCP concatenation.

For example, in the illustrated embodiment packet 1904, packet 1906, and packet 1908 combined are equal to or smaller than the maximum concatenated PDU size 1912. Accordingly, the transmitting device may perform PDCP concatenation for packet 1904, packet 1906, and packet 1908 to generate C-PDCP PDU 1910. If packet 1914 were included in C-PDCP PDU 1910, it would put the C-PDCP PDU 1910 above the maximum concatenated PDU size 1912. Accordingly, the packet 1914 may be included in its own PDCP PDU 1916.

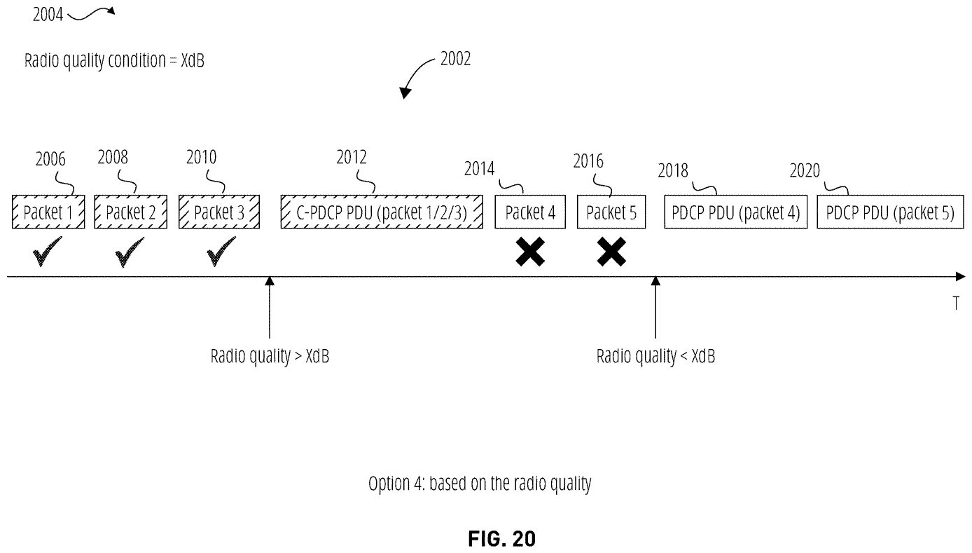

FIG. 20 illustrates an example timeline 2002 where a PDCP concatenation condition is based on the radio quality in accordance with some embodiments (e.g., option 4). PDCP concatenation functionality may be disabled when the radio quality less than a threshold.

For example, in the illustrated embodiment packet 2006, packet 2008, and packet 2010 are align with when the radio quality is greater than the radio quality condition 2004. Accordingly, the transmitting device may perform PDCP concatenation for packet 2006, packet 2008, and packet 2010 to generate the C-PDCP PDU 2012.

In contrast, packet 2014 and packet 2016 align with when the radio quality is less than the radio quality condition 2004. Accordingly, they are not concatenated and two PDCP PDUs (PDCP PDU 2018 and PDCP PDU 2020) are generated.

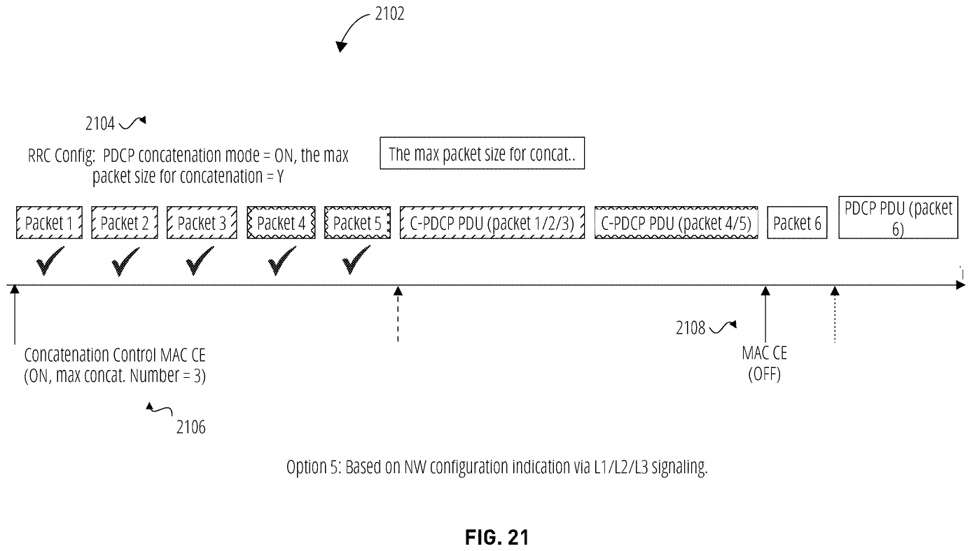

FIG. 21 illustrates an example timeline 2102 where a PDCP concatenation condition is based on network configuration indication via L1/L2/L3 signaling in accordance with some embodiments (e.g., option 5). The network can provide the semi-static control based on its knowledge and its scheduling scheme. The signaling can include one or more of concatenation mode ON/OFF, the max PDCP SDU size for concatenation, the max concatenated PDU size, or the max number of PDCP SDU for concatenation.

For example, in the illustrated embodiment, the network may provide an RRC configuration 2104 that indicates the PDCP concatenation mode is on and the max packet size for concatenation is Y. The MAC CE 2106 may provide an indication that the UE should do PDCP concatenation and provide implementation details. For example, max number of packets that UE should concatenate is three in the illustrated embodiment. A second MAC CE 2108 may be used to turn PDCP concatenation mode off.

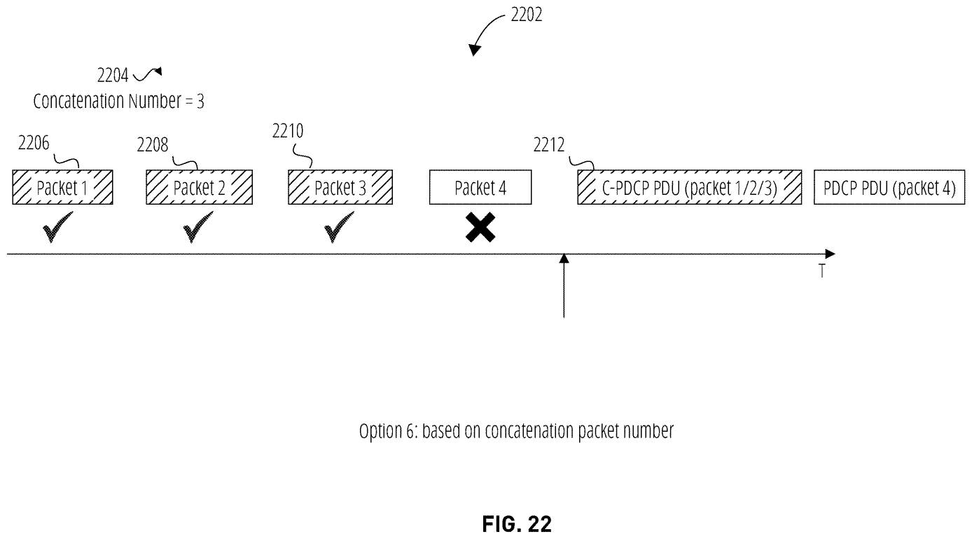

FIG. 22 illustrates an example timeline 2202 where a PDCP concatenation condition is based on concatenation packet number in accordance with some embodiments (e.g., option 6). In non-terrestrial network (NTN) deployment, to ensure the transmission efficiency and reliability, NW may expect UE to transmit multiple small packets in one TBSize with transmission repetition scheme. PDCP Tx side can based on the association between repetition number and number of voice packet to decide the concatenated number. In the illustrated embodiment, the concatenation number 2204 is set to three, so packet 1 2206, packet 2 2208 and packet 3 2210 are all concatenated in C-DCP PDU 2212.

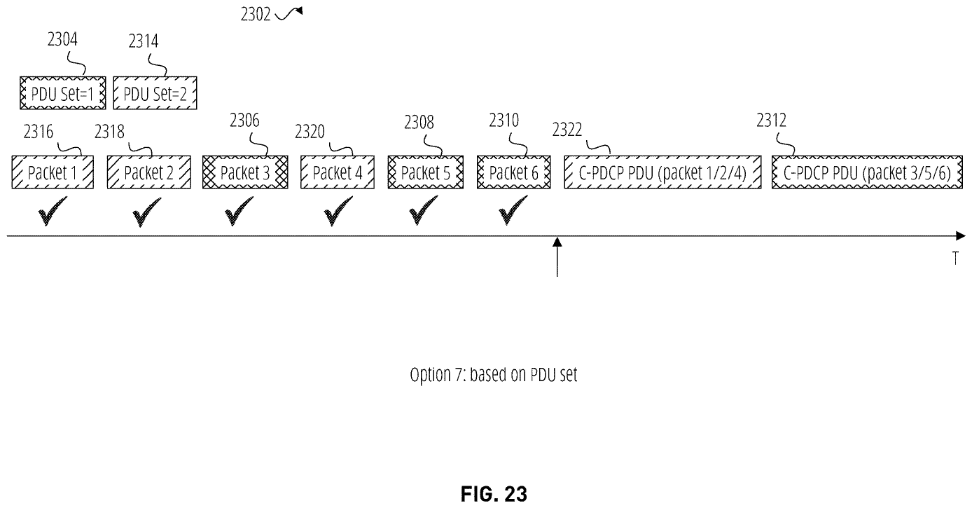

FIG. 23 illustrates an example timeline 2302 where a PDCP concatenation condition is based on PDU set in accordance with some embodiments (e.g., option 7). In the illustrated embodiment, the transmitting device may concatenate the packets from the same PDU set together.

For example, packet 2306, packet 2308, and 2310 are all part of PDU set 2304. Accordingly, a transmitting device may concatenate these packets to generate C-PDCP PDU 2312. Similarly, packet 2316, packet 2318, and 2320 are all part of PDU set 2314. Accordingly, a transmitting device may concatenate these packets to generate C-PDCP PDU 2322.

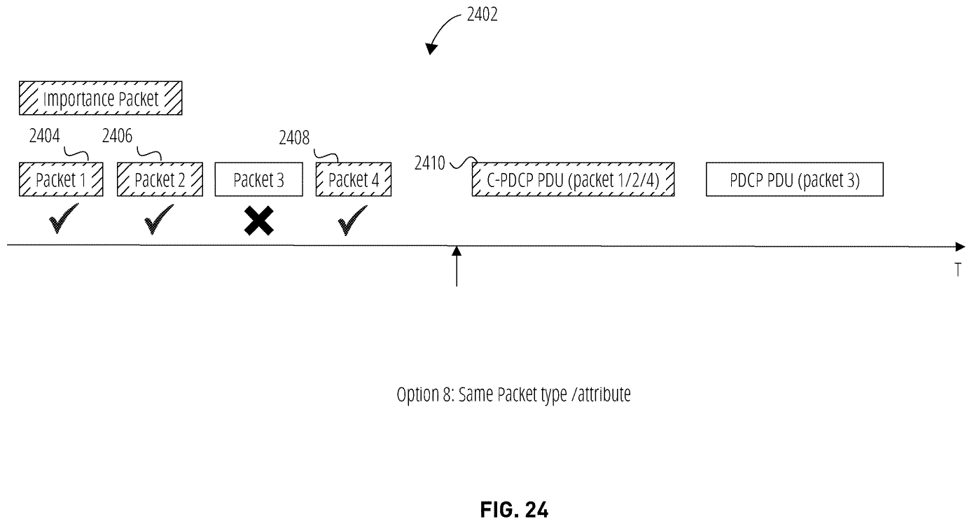

FIG. 24 illustrates an example timeline 2402 where a PDCP concatenation condition is based on packet type/attribute in accordance with some embodiments (e.g., option 8). In the illustrated embodiment, the packets with the same packet type are concatenated. For example, in the illustrated embodiment, packet 2404, packet 2406, and packet 2408 are the same packet type and are concatenated to generate C-PDCP PDU 2410.

Some embodiments here consider PDCP SDU discard mechanism with PDCP concatenation. In legacy PDCP SDU a discard timer is maintained per PDCP SDU to control the lifetime of each packet in access stratum (AS) layer. Upon SDU discard timer expiry, if the PDCP SDU has not been delivered out, UE will discard the PDCP SDU. But for the virtual PDCP SDU (e.g., the PDCP SDUs in a C-PDCP), it is not clear whether the discard timer should be maintained per virtual PDCP SDU or PDCP SDU.

In some embodiments, PDCP SDU discard operation for a C-PDCP may be as follows. The discard timer may be maintained per PDCP SDU. The UE may start the PDCP discard timer per PDCP SDU. In some embodiments, if the PDCP SDU is discarded (due to discard timer expiry), and the C-PDCP PDU has already been generated, UE can discard this PDCP SDU, and regenerate the C-PDCP PDU, or the UE can update the header information to skip the PDCP SDU. Note that in some embodiments when Tx side regenerates the C-PDCP PDU due to some SDU discarding, it can carry new PDCP SDU inside.

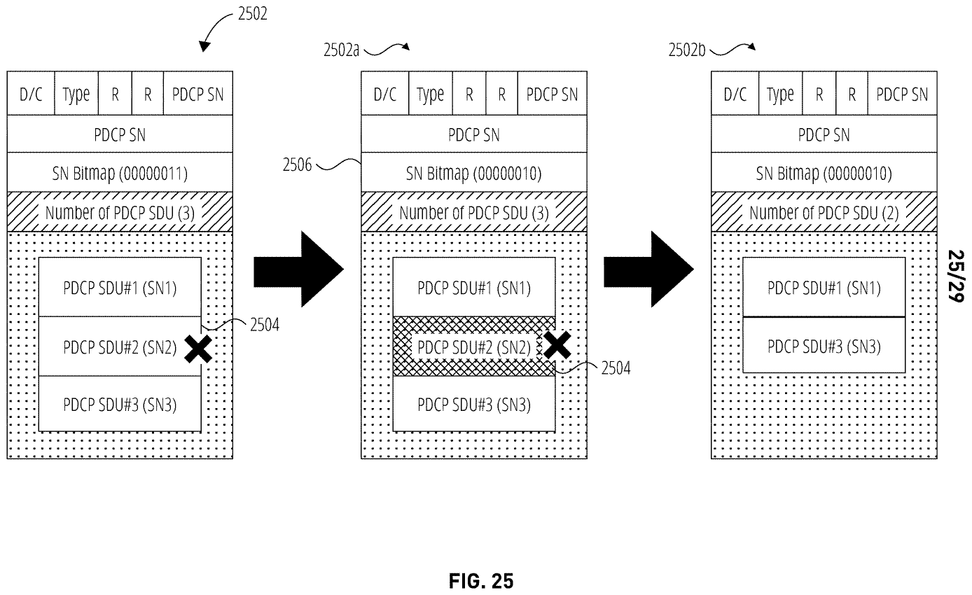

FIG. 25 illustrates an example operation of a UE implementing a PDCP SDU discard mechanism in conjunction with PDCP concatenation in accordance with some embodiments. The UE may maintain a PDCP discard timer on a per-PDCP SDU basis for the C-PDCP PDU 2502. In the illustrated embodiment, three PDCP SDUs are concatenated to generate the C-PDCP PDU 2502.

In the illustrated example, while the C-PDCP PDU 2502 is pending transmission or has been generated but not yet delivered to the lower layer, the discard timer associated with one PDCP SDU 2504 expires. In the illustrated embodiment, upon expiry of the PDCP discard timer, the UE determines that the corresponding PDCP SDU 2504 has exceeded its permitted lifetime and discards the PDCP SDU in accordance with the discard procedure.

Following the discard of the PDCP SDU, the UE may perform a regeneration operation for the C-PDCP PDU 2502. Specifically, the UE removes the discarded PDCP SDU from the concatenation process and regenerates the C-PDCP PDU 2502 without including the discarded PDCP SDU 2504.

In some embodiments, the UE may update header or control information of the previously generated concatenated PDCP PDU to logically skip the discarded PDCP SDU. For example, in the illustrated embodiment, C-PDCP PDU 2502a represents a C-PDCP PDU where the SN bitmap 2506 is updated to indicate that PDCP SDU 2504 should be skipped by the receiving side. In such embodiments, the concatenation process may not be used again and PDCP SDU 2504 remains in the C-PDCP PDU 2502 but will be skipped by the receiving side.

In some embodiments, the UE may reconstruct the PDCP PDU by concatenating the remaining valid PDCP SDUs. For example, in the illustrated embodiment, C-PDCP PDU 2502b represents an embodiment where the PDCP SDUs are concatenated again but without PDCP SDU 2504. Thus, PDCP SDU 2504 may be removed at the PDCP layer and the C-PDCP PDU 2502b is regenerated.

In some embodiments, PDCP SDU retransmission with PDCP concatenation may be used. In 6G PDCP ARQ (i.e. PDCP packet retransmission) may not only triggered by radio resource control (RRC), but also triggered based on the feedback from a peer entity.

In some embodiments, the operations related to PDCP SDU retransmission with PDCP concatenation may be as follows. The operations of the Rx side may include: Transmit the PDCP status report to indicate the reception status in PDCP SDU level. The operations of the Tx side may include: Perform the PDCP SDU retransmission. UE can perform the PDCP SDU retransmission in the concatenated PDU or standalone PDU, based on the current situation. If the concatenation condition is met, UE can concatenate the retransmitted PDCP SDU and new transmitted PDCP PDU in one PDCP PDU.

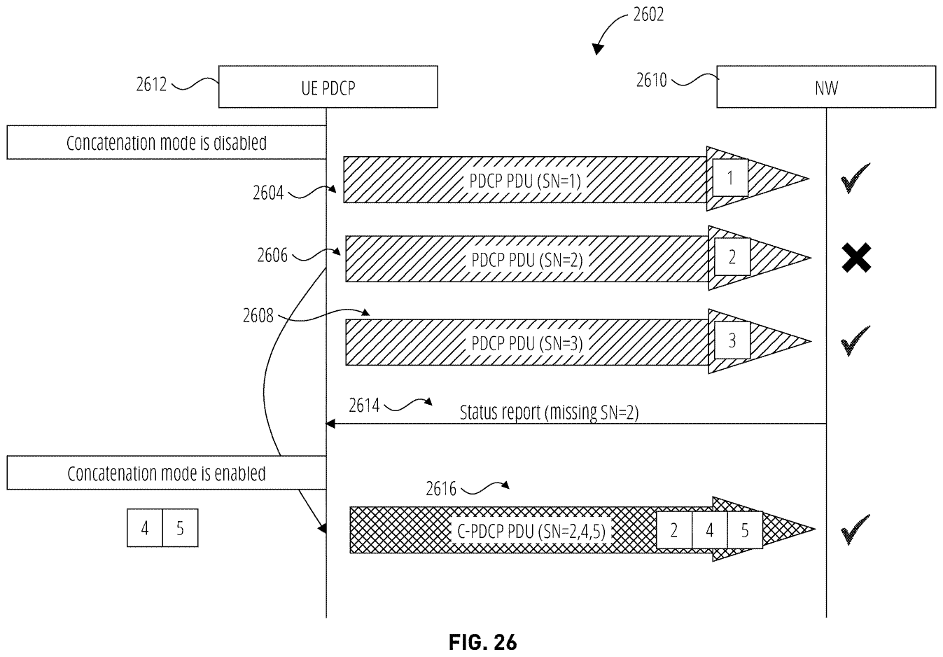

For example, FIG. 26 an example signal flow diagram 2602 PDCP SDU retransmission with PDCP concatenation in accordance with some embodiments. In the illustrated example, concatenation mode is initially disabled. While the concatenation mode is disabled, the UE transmits PDCP PDUs (e.g., PDCP DPU 2604, PDCP PDU 2606, PDCP PDU 2608) associated with PDCP SDU with sequence numbers 1, 2, and 3. At this time, PDCP concatenation is not enabled, and the PDCP SDUs is transmitted as standalone PDCP PDUs from the UE 2612 to the network 2610.

Subsequently, the network 2610 determines that a previously transmitted PDCP SDU (e.g., SDU included in PDCP PDU 2606) was not successfully received. The network 2610 may transmit a PDCP status report 2614 or feedback message to the UE 2612 indicating that the PDCP SDU with sequence number 2 is missing. Upon receiving this feedback, the UE 2612 may determine that retransmission of the PDCP SDU with sequence number 2 is required.

At the retransmission time point, the UE 2612 may evaluate the current transmission conditions and determine to enable PDCP concatenation. At substantially the same time, one or more new PDCP SDUs, for example PDCP SDUs having sequence numbers 4 and 5, may arrive at the PDCP layer for initial transmission. Based on the current situation, the UE 2612 may decide to include both the retransmitted PDCP SDU and the newly arrived PDCP SDUs in a single concatenated PDCP PDU 2612.

The example illustrates that during the PDCP SDU retransmission procedure, the PDCP concatenation mode may not be required to remain the same as that used during the original transmission. Instead, the concatenation mode may be dynamically changed based on current transmission conditions, buffering status, or scheduling considerations, thereby providing flexibility and improved transmission efficiency during PDCP SDU retransmission operations.

In some embodiments, data forwarding during the handover between Nodes may be considered in combination with PDCP concatenation. During the handover, a source network node may forward the UE's data to the target network node in data radio bearer (DRB) level. In downlink, for all the packets without PDCP SN preservation, source network node may forward the QoS flow to the target network node based on flow-DRB mapping in source network node. For DRB with the preservation of SN status applies, source network node may forward the PDCP SDU with SN corresponding to the PDCP PDU which has not been ACK by UE to target network node. In uplink, the source network node may not forward the PDCP PDU received out of sequence in source network node to target network node, or forward the PDCP PDU received out of sequence in source network node to target network node. The packet transmitted between network nodes may be in single PDCP SDU level. The system may also keep the legacy operation.

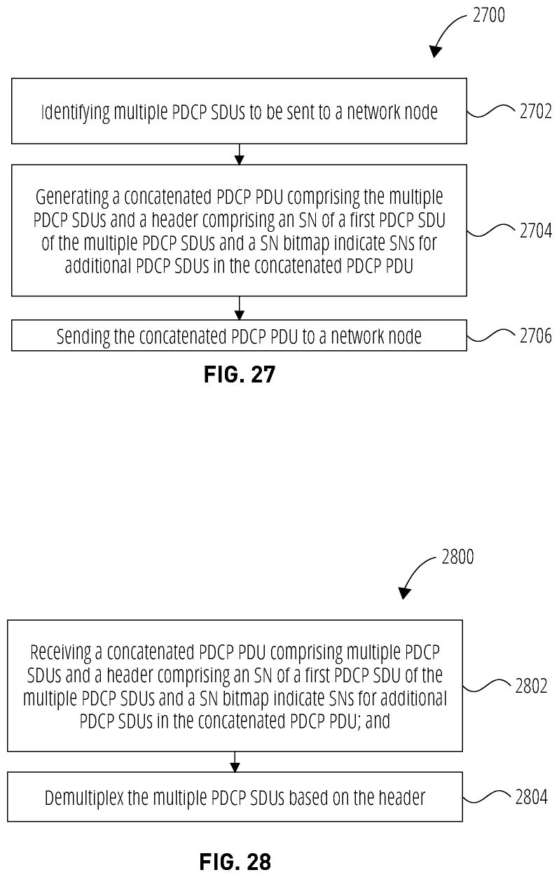

FIG. 27 illustrates a method 2700 for a UE in accordance with some embodiments. The illustrated method 2700 includes identifying 2702 multiple PDCP SDUs to be sent to a network node. The method 2700 further includes generating 2704 a concatenated PDCP PDU comprising the multiple PDCP SDUs and a header comprising an SN of a first PDCP SDU of the multiple PDCP SDUs and a SN bitmap indicates SNs for additional PDCP SDUs in the concatenated PDCP PDU. The method 2700 further includes sending 2706 the concatenated PDCP PDU to a network node.

In some embodiments, the method 2700 further comprises performing security protection per PDCP SDU included in the concatenated PDCP PDU.

In some embodiments, the method 2700 further comprises performing security protection for one or a subset of the multiple PDCP SDUs.

In some embodiments, the method 2700 further comprises performing security protection for the concatenated PDCP PDU as a whole, wherein the security protection is based on the SN of a specific PDCP SDU of the multiple PDCP SDUs.

In some embodiments of the method 2700, the header further comprises a length of each of the multiple PDCP SDUS.

In some embodiments of the method 2700, the header further comprises a field that indicates a number of the multiple PDCP SDUs, wherein the multiple PDCP SDUs are a same size.

In some embodiments of the method 2700, the concatenated PDCP PDU is generated based on one or more conditions being met. In some such embodiments, concatenating the multiple PDCP SDUs is based on one or more of a timer, PDCP SDU size, packet size, C-PDCP size, radio quality, network configuration, repetition number, PDU set, or packet type.

In some embodiments, the method 2700 further comprises starting discard timers for each of the multiple PDCP SDUs, and in response to a first discard timer expire, discarding a first PDCP SDU associated with the first discard timer and regenerating the concatenated PDCP PDU without the discarded SDU.

In some embodiments, the method 2700 further comprises starting discard timers for each of the multiple PDCP SDUs, and in response to a first discard timer expire, updating the header to indicate to the network node to skip a first PDCP SDU associated with the first discard timer.

In some embodiments, the method 2700 further comprises receiving, from the network node, a PDCP status report indicating a reception status at a PDCP SDU level, wherein the PDCP status report indicates that at least one failed PDCP SDU, determining if a concatenation condition is met, and in response to the concatenation condition being met, retransmitting the failed PDCP SDU concatenated with one or more new PDCP SDUs.

FIG. 28 illustrates a method 2800 for a network node in accordance with some embodiments. The illustrated method 2800 includes receiving 2802 a concatenated PDCP PDU comprising multiple PDCP SDUs and a header comprising an SN of a first PDCP SDU of the multiple PDCP SDUs and a SN bitmap indicating SNs for additional PDCP SDUs in the concatenated PDCP PDU. The method 2800 further includes demultiplexing 2804 the multiple PDCP SDUs based on the header.

In some embodiments of the method 2800, the security protection of the concatenated PDCP PDU is per PDCP SDU included in the concatenated PDCP PDU.

In some embodiments of the method 2800, the security protection of the concatenated PDCP PDU is associated with one or a subset of the multiple PDCP SDUs.

In some embodiments of the method 2800, the security protection of the concatenated PDCP PDU is for the concatenated PDCP PDU as a whole, wherein the security protection is based on the SN of a specific PDCP SDU of the multiple PDCP SDUs.

In some embodiments of the method 2800, the header further comprises a length of each of the multiple PDCP SDUs.

In some embodiments of the method 2800, the header further comprises a field that indicates a number of the multiple PDCP SDUs, wherein the multiple PDCP SDUs are a same size.

In some embodiments of the method 2800, the concatenated PDCP PDU is generated based on one or more conditions being met. In some such embodiments, the one or more conditions comprises on one or more of a timer, PDCP SDU size, packet size, C-PDCP size, radio quality, network configuration, repetition number, PDU set, or packet type.

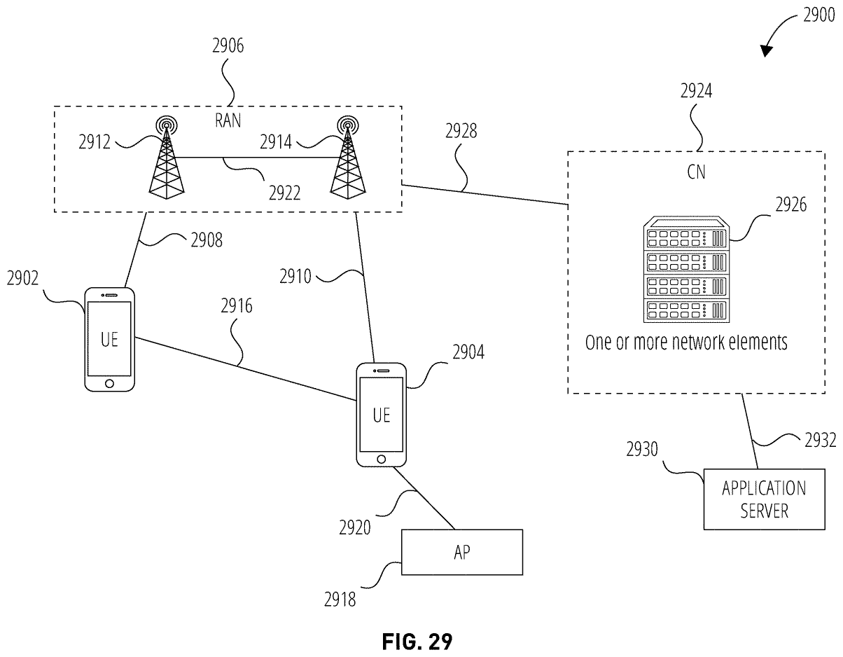

FIG. 29 illustrates an example architecture of a wireless communication system 2900, according to embodiments disclosed herein. The following description is provided for an example wireless communication system 2900 that operates in conjunction with the LTE system standards and/or 5G or NR system standards as provided by 3GPP technical specifications.

As shown by FIG. 29, the wireless communication system 2900 includes UE 2902 and UE 2904 (although any number of UEs may be used). In this example, the UE 2902 and the UE 2904 are illustrated as smartphones (e.g., handheld touchscreen mobile computing devices connectable to one or more cellular networks), but may also comprise any mobile or non-mobile computing device configured for wireless communication.

The UE 2902 and UE 2904 may be configured to communicatively couple with a RAN 2906. In embodiments, the RAN 2906 may be NG-RAN, E-UTRAN, etc. The UE 2902 and UE 2904 utilize connections (or channels) (shown as connection 2908 and connection 2910, respectively) with the RAN 2906, each of which comprises a physical communications interface. The RAN 2906 can include one or more base stations (such as base station 2912 and base station 2914) that enable the connection 2908 and connection 2910.

In this example, the connection 2908 and connection 2910 are air interfaces to enable such communicative coupling, and may be consistent with RAT(s) used by the RAN 2906, such as, for example, an LTE and/or NR.

In some embodiments, the UE 2902 and UE 2904 may also directly exchange communication data via a sidelink interface 2916. The UE 2904 is shown to be configured to access an access point (shown as AP 2918) via connection 2920. By way of example, the connection 2920 can comprise a local wireless connection, such as a connection consistent with any IEEE 802.11 protocol, wherein the AP 2918 may comprise a Wi-Fi® router. In this example, the AP 2918 may be connected to another network (for example, the Internet) without going through a CN 2924.

In embodiments, the UE 2902 and UE 2904 can be configured to communicate using orthogonal frequency division multiplexing (OFDM) communication signals with each other or with the base station 2912 and/or the base station 2914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2912 or base station 2914 may be implemented as one or more software entities running on server computers as part of a virtual network. In addition, or in other embodiments, the base station 2912 or base station 2914 may be configured to communicate with one another via interface 2922. In embodiments where the wireless communication system 2900 is an LTE system (e.g., when the CN 2924 is an EPC), the interface 2922 may be an X2 interface. The X2 interface may be defined between two or more base stations (e.g., two or more eNBs and the like) that connect to an EPC, and/or between two eNBs connecting to the EPC. In embodiments where the wireless communication system 2900 is an NR system (e.g., when CN 2924 is a 5GC), the interface 2922 may be an Xn interface. The Xn interface is defined between two or more base stations (e.g., two or more gNBs and the like) that connect to 5GC, between a base station 2912 (e.g., a gNB) connecting to 5GC and an eNB, and/or between two eNBs connecting to 5GC (e.g., CN 2924).

The RAN 2906 is shown to be communicatively coupled to the CN 2924. The CN 2924 may comprise one or more network elements 2926, which are configured to offer various data and telecommunications services to customers/subscribers (e.g., users of UE 2902 and UE 2904) who are connected to the CN 2924 via the RAN 2906. The components of the CN 2924 may be implemented in one physical device or separate physical devices including components to read and execute instructions from a machine-readable or computer-readable medium (e.g., a non-transitory machine-readable storage medium).

In embodiments, the CN 2924 may be an EPC, and the RAN 2906 may be connected with the CN 2924 via an S1 interface 2928. In embodiments, the S1 interface 2928 may be split into two parts, an S1 user plane (S1-U) interface, which carries traffic data between the base station 2912 or base station 2914 and a serving gateway (S-GW), and the S1-MME interface, which is a signaling interface between the base station 2912 or base station 2914 and mobility management entities (MMEs).

In embodiments, the CN 2924 may be a 5GC, and the RAN 2906 may be connected with the CN 2924 via an NG interface 2928. In embodiments, the NG interface 2928 may be split into two parts, an NG user plane (NG-U) interface, which carries traffic data between the base station 2912 or base station 2914 and a user plane function (UPF), and the S1 control plane (NG-C) interface, which is a signaling interface between the base station 2912 or base station 2914 and access and mobility management functions (AMFs).

Generally, an application server 2930 may be an element offering applications that use internet protocol (IP) bearer resources with the CN 2924 (e.g., packet switched data services). The application server 2930 can also be configured to support one or more communication services (e.g., VoIP sessions, group communication sessions, etc.) for the UE 2902 and UE 2904 via the CN 2924. The application server 2930 may communicate with the CN 2924 through an IP communications interface 2932.

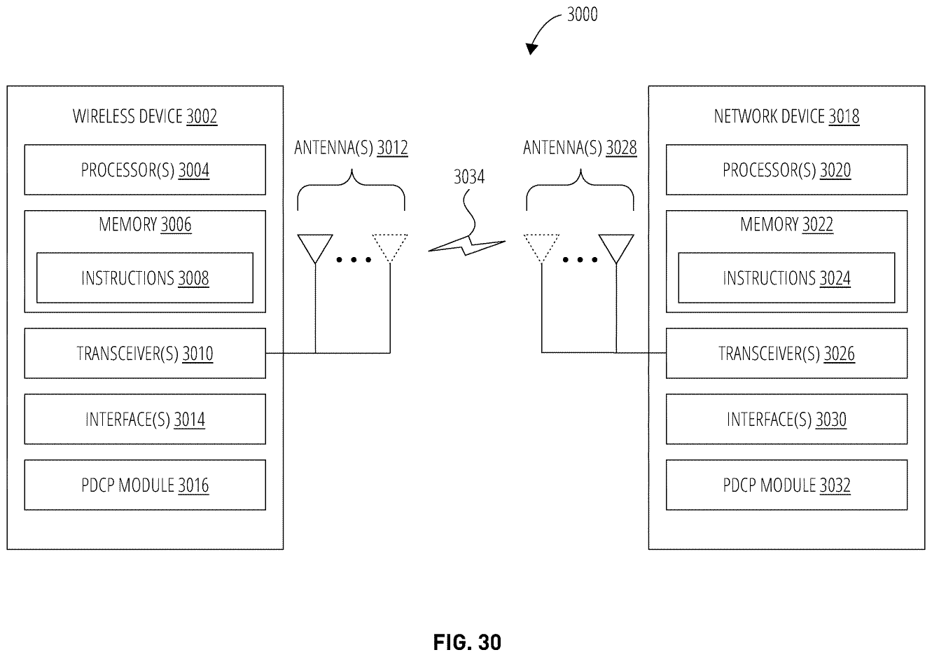

FIG. 30 illustrates a system 3000 for performing signaling 3034 between a wireless device 3002 and a network device 3018, according to embodiments disclosed herein. The system 3000 may be a portion of a wireless communications system as herein described. The wireless device 3002 may be, for example, a UE of a wireless communication system. The network device 3018 may be, for example, a base station (e.g., an eNB or a gNB) of a wireless communication system.

The wireless device 3002 may include one or more processor(s) 3004. The processor(s) 3004 may execute instructions such that various operations of the wireless device 3002 are performed, as described herein. The processor(s) 3004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 3002 may include a memory 3006. The memory 3006 may be a non-transitory computer-readable storage medium that stores instructions 3008 (which may include, for example, the instructions being executed by the processor(s) 3004). The instructions 3008 may also be referred to as program code or a computer program. The memory 3006 may also store data used by, and results computed by, the processor(s) 3004.

The wireless device 3002 may include one or more transceiver(s) 3010 that may include radio frequency (RF) transmitter circuitry and/or receiver circuitry that use the antenna(s) 3012 of the wireless device 3002 to facilitate signaling (e.g., the signaling 3034) to and/or from the wireless device 3002 with other devices (e.g., the network device 3018) according to corresponding RATs.

The wireless device 3002 may include one or more antenna(s) 3012 (e.g., one, two, four, or more). For embodiments with multiple antenna(s) 3012, the wireless device 3002 may leverage the spatial diversity of such multiple antenna(s) 3012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 3002 may be accomplished according to precoding (or digital beamforming) that is applied at the wireless device 3002 that multiplexes the data streams across the antenna(s) 3012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 3002 may implement analog beamforming techniques, whereby phases of the signals sent by the antenna(s) 3012 are relatively adjusted such that the (joint) transmission of the antenna(s) 3012 can be directed (this is sometimes referred to as beam steering).

The wireless device 3002 may include one or more interface(s) 3014. The interface(s) 3014 may be used to provide input to or output from the wireless device 3002. For example, a wireless device 3002 that is a UE may include interface(s) 3014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 3010/antenna(s) 3012 already described) that allow for communication between the UE and other devices and may operate according to known protocols (e.g., Wi-Fi®, Bluetooth®, and the like).

The wireless device 3002 may include a PDCP module 3016. The PDCP module 3016 may be implemented via hardware, software, or combinations thereof. For example, the PDCP module 3016 may be implemented as a processor, circuit, and/or instructions 3008 stored in the memory 3006 and executed by the processor(s) 3004. In some examples, the PDCP module 3016 may be integrated within the processor(s) 3004 and/or the transceiver(s) 3010. For example, the PDCP module 3016 may be implemented by a combination of software components (e.g., executed by a DSP or a general processor) and hardware components (e.g., logic gates and circuitry) within the processor(s) 3004 or the transceiver(s) 3010. The PDCP module 3016 may be used for various aspects of the present disclosure, as described herein. For example, the PDCP module 3016 may be configured to cause the wireless device 3002 to identify multiple PDCP SDUs to be sent to a network node. The PDCP module 3016 may be configured to further cause the wireless device 3002 to generate a concatenated PDCP PDU comprising the multiple PDCP SDUs, and a header comprising an SN of a first PDCP SDU of the multiple PDCP SDUs and a SN bitmap indicating SNs for additional PDCP SDUs in the concatenated PDCP PDU. The PDCP module 3016 may be configured to further cause the wireless device 3002 to send the concatenated PDCP PDU to a network device 3018.

The network device 3018 may include one or more processor(s) 3020. The processor(s) 3020 may execute instructions such that various operations of the network device 3018 are performed, as described herein. The processor(s) 3020 may include one or more baseband processors implemented using, for example, a CPU, a DSP, an ASIC, a controller, an FPGA device, another hardware device, a firmware device, or any combination thereof configured to perform the operations described herein.

The network device 3018 may include a memory 3022. The memory 3022 may be a non-transitory computer-readable storage medium that stores instructions 3024 (which may include, for example, the instructions being executed by the processor(s) 3020). The instructions 3024 may also be referred to as program code or a computer program. The memory 3022 may also store data used by, and results computed by, the processor(s) 3020.

The network device 3018 may include one or more transceiver(s) 3026 that may include RF transmitter circuitry and/or receiver circuitry that use the antenna(s) 3028 of the network device 3018 to facilitate signaling (e.g., the signaling 3034) to and/or from the network device 3018 with other devices (e.g., the wireless device 3002) according to corresponding RATs.

The network device 3018 may include one or more antenna(s) 3028 (e.g., one, two, four, or more). In embodiments having multiple antenna(s) 3028, the network device 3018 may perform MIMO, digital beamforming, analog beamforming, beam steering, etc., as has been described.

The network device 3018 may include one or more interface(s) 3030. The interface(s) 3030 may be used to provide input to or output from the network device 3018. For example, a network device 3018 that is a base station may include interface(s) 3030 made up of transmitters, receivers, and other circuitry (e.g., other than the transceiver(s) 3026/antenna(s) 3028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 3018 may include a PDCP module 3032. The PDCP module 3032 may be implemented via hardware, software, or combinations thereof. For example, the PDCP module 3032 may be implemented as a processor, circuit, and/or instructions 3024 stored in the memory 3022 and executed by the processor(s) 3020. In some examples, the PDCP module 3032 may be integrated within the processor(s) 3020 and/or the transceiver(s) 3026. For example, the PDCP module 3032 may be implemented by a combination of software components (e.g., executed by a DSP or a general processor) and hardware components (e.g., logic gates and circuitry) within the processor(s) 3020 or the transceiver(s) 3026. The PDCP module 3032 may be used for various aspects of the present disclosure, as described herein. For example, the PDCP module 3032 may be configured to cause the network device 3018 to receive a concatenated PDCP PDU comprising multiple PDCP SDUs, and a header comprising an SN of a first PDCP SDU of the multiple PDCP SDUs and a SN bitmap indicating SNs for additional PDCP SDUs in the concatenated PDCP PDU. The PDCP module 3032 may be configured to further cause the network device 3018 to demultiplex the multiple PDCP SDUs based on the header.

Embodiments contemplated herein include an apparatus comprising means to perform one or more elements of the method 2700. This apparatus may be, for example, an apparatus of a UE (such as a wireless device 3002 that is a UE, as described herein).

Embodiments contemplated herein include one or more non-transitory computer-readable media comprising instructions to cause an electronic device, upon execution of the instructions by one or more processors of the electronic device, to perform one or more elements of the method 2700. This non-transitory computer-readable media may be, for example, a memory of a UE (such as a memory 3006 of a wireless device 3002 that is a UE, as described herein).

Embodiments contemplated herein include an apparatus comprising logic, modules, or circuitry to perform one or more elements of the method 2700. This apparatus may be, for example, an apparatus of a UE (such as a wireless device 3002 that is a UE, as described herein).

Embodiments contemplated herein include an apparatus comprising: one or more processors and one or more computer-readable media comprising instructions that, when executed by the one or more processors, cause the one or more processors to perform one or more elements of the method 2700. This apparatus may be, for example, an apparatus of a UE (such as a wireless device 3002 that is a UE, as described herein).

Embodiments contemplated herein include a signal as described in or related to one or more elements of the method 2700.

Embodiments contemplated herein include a computer program or computer program product comprising instructions, wherein execution of the program by a processor is to cause the processor to carry out one or more elements of the method 2700. The processor may be a processor of a UE (such as a processor(s) 3004 of a wireless device 3002 that is a UE, as described herein). These instructions may be, for example, located in the processor and/or on a memory of the UE (such as a memory 3006 of a wireless device 3002 that is a UE, as described herein).

Embodiments contemplated herein include an apparatus comprising means to perform one or more elements of the method 2800. This apparatus may be, for example, an apparatus of a base station (such as a network device 3018 that is a base station, as described herein).

Embodiments contemplated herein include one or more non-transitory computer-readable media comprising instructions to cause an electronic device, upon execution of the instructions by one or more processors of the electronic device, to perform one or more elements of the method 2800. This non-transitory computer-readable media may be, for example, a memory of a base station (such as a memory 3022 of a network device 3018 that is a base station, as described herein).

Embodiments contemplated herein include an apparatus comprising logic, modules, or circuitry to perform one or more elements of the method 2800. This apparatus may be, for example, an apparatus of a base station (such as a network device 3018 that is a base station, as described herein).

Embodiments contemplated herein include an apparatus comprising: one or more processors and one or more computer-readable media comprising instructions that, when executed by the one or more processors, cause the one or more processors to perform one or more elements of the method 2800. This apparatus may be, for example, an apparatus of a base station (such as a network device 3018 that is a base station, as described herein).

Embodiments contemplated herein include a signal as described in or related to one or more elements of the method 2800.

Embodiments contemplated herein include a computer program or computer program product comprising instructions, wherein execution of the program by a processing element is to cause the processing element to carry out one or more elements of the method 2800. The processor may be a processor of a base station (such as a processor(s) 3020 of a network device 3018 that is a base station, as described herein). These instructions may be, for example, located in the processor and/or on a memory of the base station (such as a memory 3022 of a network device 3018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus for a user equipment (UE), comprising:
one or more baseband processors configured to cause the UE to:
identify multiple packet data convergence protocol (PDCP) service data units (SDUs) to be sent to a network node;
generate a concatenated PDCP packet data unit (PDU) comprising:
the multiple PDCP SDUs; and
a header comprising a sequence number (SN) of a first PDCP SDU of the multiple PDCP SDUs and a SN bitmap indicating SNs for additional PDCP SDUs in the concatenated PDCP PDU; and
send the concatenated PDCP PDU to a network node.

2. The apparatus of claim 1, wherein the instructions further configure the apparatus to perform security protection per PDCP SDU included in the concatenated PDCP PDU.

3. The apparatus of claim 1, wherein the instructions further configure the apparatus to perform security protection for one or a subset of the multiple PDCP SDUs.

4. The apparatus of claim 1, wherein the instructions further configure the apparatus to perform security protection for the concatenated PDCP PDU as a whole, wherein the security protection is based on the SN of a specific PDCP SDU of the multiple PDCP SDUs.

5. The apparatus of claim 1, wherein the header further comprises a length of each of the multiple PDCP SDUs.

6. The apparatus of claim 1, wherein the header further comprises a field that indicates a number of the multiple PDCP SDUs, wherein the multiple PDCP SDUs are a same size.

7. The apparatus of claim 1, wherein the concatenated PDCP PDU is generated based on one or more conditions being met.

8. The apparatus of claim 7, wherein concatenating the multiple PDCP SDUs is based on one or more of a timer, PDCP SDU size, packet size, C-PDCP size, radio quality, network configuration, repetition number, PDU set, or packet type.

9. The apparatus of claim 1, wherein the instructions further configure the apparatus to:
start discard timers for each of the multiple PDCP SDUs;
in response to a first discard timer expire, discarding a first PDCP SDU associated with the first discard timer and regenerating the concatenated PDCP PDU without the discarded SDU.

10. The apparatus of claim 1, wherein the instructions further configure the apparatus to:
start discard timers for each of the multiple PDCP SDUs;
in response to a first discard timer expire, updating the header to indicate to the network node to skip a first PDCP SDU associated with the first discard timer.

11. The apparatus of claim 1, wherein the instructions further configure the apparatus to:
receive, from the network node, a PDCP status report indicating a reception status at a PDCP SDU level, wherein the PDCP status report indicates that at least one failed PDCP SDU;
determine if a concatenation condition is met; and
in response to the concatenation condition being met, retransmit the failed PDCP SDU concatenated with one or more new PDCP SDUs.

12. A method for a user equipment (UE), the method comprising:
identifying multiple packet data convergence protocol (PDCP) service data units (SDUs) to be sent to a network node;
generating a concatenated PDCP packet data unit (PDU) comprising:
the multiple PDCP SDUs; and
a header comprising a sequence number (SN) of a first PDCP SDU of the multiple PDCP SDUs and a SN bitmap indicating SNs for additional PDCP SDUs in the concatenated PDCP PDU; and
sending the concatenated PDCP PDU to a network node.

13. A non-transitory computer-readable storage medium, the computer-readable storage medium including instructions that when executed by a network node, cause the network node to:
receive a concatenated packet data convergence protocol (PDCP) packet data unit (PDU) comprising:
multiple PDCP service data units (SDUs); and
a header comprising a sequence number (SN) of a first PDCP SDU of the multiple PDCP SDUs and a SN bitmap indicating SNs for additional PDCP SDUs in the concatenated PDCP PDU; and
demultiplex the multiple PDCP SDUs based on the header.

14. The computer-readable storage medium of claim 13, wherein the security protection of the concatenated PDCP PDU is per PDCP SDU included in the concatenated PDCP PDU.

15. The computer-readable storage medium of claim 13, wherein the security protection of the concatenated PDCP PDU is associated with one or a subset of the multiple PDCP SDUs.

16. The computer-readable storage medium of claim 13, wherein the security protection of the concatenated PDCP PDU is for the concatenated PDCP PDU as a whole, wherein the security protection is based on the SN of a specific PDCP SDU of the multiple PDCP SDUs.

17. The computer-readable storage medium of claim 13, wherein the header further comprises a length of each of the multiple PDCP SDUs.

18. The computer-readable storage medium of claim 13, wherein the header further comprises a field that indicates a number of the multiple PDCP SDUs, wherein the multiple PDCP SDUs are a same size.

19. The computer-readable storage medium of claim 13, wherein the concatenated PDCP PDU is generated based on one or more conditions being met.

20. The computer-readable storage medium of claim 19, wherein the one or more conditions comprises on one or more of a timer, PDCP SDU size, packet size, C-PDCP size, radio quality, network configuration, repetition number, PDU set, or packet type.
